(19) United States
(12) Patent Application Publication
(10) Pub. No.: US 2012/0129928 A1
(43) Pub. Date: May 24, 2012

(54) Chlorine-Free Liquid Microbicide Treatment

(75) Inventors: Michael P. Doyle, Peachtree City, GA (US); Tong Zhao, Peachtree City, GA (US)

(73) Assignee: University of Georgia Research Foundation, Inc., Athens, GA (US)

(21) Appl. No.: 13/351,477

(22) Filed: Jan. 17, 2012

Related U.S. Application Data
(63) Continuation-in-part of application No. 13/234,286, filed on Sep. 16, 2011.
(60) Provisional application No. 61/384,528, filed on Sep. 20, 2010.
(60) Provisional application No. 61/433,623, filed on Jan. 18, 2011.
(60) Provisional application No. 61/445,625, filed on Feb. 23, 2011.

(51) Int. Cl. A01N 41/04; A01P 1/00

(52) U.S. Cl. 514/517

(57) ABSTRACT

The combination of the surfactant SDS with levulinic acid produces a synergistic effect in relation to the antimicrobial effectiveness of the individual compounds. Accordingly, this surprising synergy allows the formulation of compositions wherein the active agents are present at concentrations effective to reduce bacterial counts in liquids, including, but not limited to, water and other beverages, especially those having a pH value less than about 7.0 by a factor between 10³ and 10⁷ without altering the organoleptic properties of the treated food substance. The active agents are FDA-approved as food additives, and the treated beverages can be any aqueous-based beverage consumable by humans or animals.

### CROSS-REFERENCE TO RELATED APPLICATIONS

This application is a U.S. Continuation-in-Part of pending U.S. non-provisional application Ser. No. 13/234,286, entitled “CHLORINE-FREE WATER TREATMENT” filed Sep. 16, 2011, which claims priority from U.S. Provisional Patent Application Ser. No. 61/384,528, entitled “CHLORINE-FREE WATER TREATMENT” filed on Sep. 20, 2010, and further claims priority from U.S. Provisional Patent Application Ser. No. 61/433,623, entitled “CHLORINE-FREE WATER TREATMENT” filed on Jan. 18, 2011, and from U.S. Provisional Patent Application Ser. No. 61/445,625, entitled “CHLORINE-FREE WATER TREATMENT” filed on Feb. 23, 2011, the entireties of which are hereby incorporated by reference.

### TECHNICAL FIELD

The present disclosure is generally related to methods of use of microbicidal compositions for reducing a microbial load of a liquid, and in particular of consumable beverages.

### BACKGROUND

Microbial contamination of the food supply, both of solid foods and consumable liquids, is a significant and universal problem in all societies and countries, even those widely assumed to provide “safe” food supplies. Contamination may occur at any point in the food supply line, from the source of the foodstuffs, introduced during gathering, transportation and marketing, at the point of food processing, and during storage prior to its consumption. Even with a beverage as simple as water, microbial contamination, and hence potential sources of disease, are readily found or introduced. There is a constant need, therefore, for effective means of reducing to acceptable levels (i.e. levels that do not have pathological effects on humans or animals consuming the foods or liquids) microbial contaminants and which do not initiate changes in the foodstuffs that render them unpalatable. Desirable antimicrobials, therefore, must be safe for human and animal consumption, cheap since they can be used to treat enormous amounts of consumable products, preferably of long-lasting in effectiveness, and effective in reducing the viability of a wide-range of possible contaminants.

Escherichia coli O157:H7 and Salmonella are major causes of severe food borne disease in the United States and continue to be of public health significance. Salmonella is one of the most frequent causes of food borne illnesses worldwide. In the United States, it causes an estimated 1.4 million cases of illness, approximately 20,000 hospitalizations, and more than 500 deaths annually (Mead, et al., 1999). FoodNet surveillance data of food borne illnesses revealed that the overall incidence of salmonellosis has decreased by only 8% from 1996-1998 to 2004 and the incidence of Salmonella enteritidis infections has remained at approximately the same level.

Other pathogens such as, for instance, Klebsiela, V. cholera, Proteus hauseri, Shigella, Yersinia pestis and B. anthracis, and protozoan, together with the more prominent E. coli and Salmonella, comprise a wide-spectrum of food-borne and water-borne pathogens that threaten the safety of the food supply and are now considered a matter of homeland security relevance. These food-borne and water-borne microorganisms are also associated with the spoilage of beverages such as fruit juices, and other protein and/or sugar-containing beverages. Therefore, the development of a unique, pluripotent, widely applicable, and easy to manufacture countermeasure is desirable.

Spoilage of fruit juices by Alicyclobacillus species, especially by A. acidoterrestris, has become well-recognized since 1982 and is now a beverage industry-wide problem. Beverage spoilage by Alicyclobacillus results in a flat-sour type spoilage, with off-flavor and cloudiness. The production of guaicol and halogenated phenols is responsible for the primary off flavor, characterized as smoky and medicinal. Spores of Alicyclobacillus species can survive heat pasteurization processes applied to fruits, vegetables, fruit/vegetable-based beverages, fruit concentrates and purees, sugar, sugar syrups, tea, isotonic drinks (sports drinks), and other acidic beverage-type products. The heat resistance D₉₅° C. values in juices of Alicyclobacillus spores ranges from 0.06 to 5.3 min, with z-values of 7.2 to 12.8° C.

The efficacy of levulinic acid plus SDS at different concentrations and ratios in inactivating spores of Alicyclobacillus and Bacillus species in liquid preparations. Several isolates of each genus were tested individually. We also determined the inactivation of these spore preparations by levulinic acid plus SDS in combination with a heat treatment of 65° C. for 30 min.

### SUMMARY

The combination of the surfactant SDS with levulinic acid produces a synergistic effect in relation to the antimicrobial effectiveness of the individual compounds. Accordingly, this surprising synergy allows the formulation of compositions wherein the active agents are present at concentrations effective to reduce bacterial counts in liquids, including, but not limited to, water and other beverages, especially those having a pH value less than about 7.0 by a factor between 10³ and 10⁷ without altering the organoleptic properties of the treated food substance. The active agents are FDA-approved as food additives, and the treated beverages can be any aqueous-based beverage consumable by humans or animals.

One aspect of the present disclosure, therefore, encompasses the use of a composition comprising a pharmaceutically acceptable acid and a pharmaceutically acceptable surfactant, wherein the maximum concentration of total acid present in the composition is about 0.3 to about 20% by weight per volume in water (3-200 grams/L) and the maximum concentration of total surfactant is about 0.5% to about 10% by weight per volume in water (5-100 grams/L). The pharmaceutically acceptable levulinic acid is an acid that has been classified by the US Department of Agriculture as being Generally Regarded As Safe (GRAS).

The pharmaceutically acceptable surfactant can be selected from any ionic (cationic or anionic) or non-ionic surfactants that are compatible for human use. The surfactant can be a functionalized organic acid having a hydrocarbon chain length of 2 to 20 carbons, where the functionalizing group is selected from hydroxyl, amino, carbonyl, sulphonyl, phosphate and thiol groups. Such surfactants are known to those skilled in the art in the field of food industry and one particularly useful surfactant for use in the methods of the present disclosure is sodium dodecyl sulfate (SDS).

Levulinic acid has been found to have superior qualities relative to other organic acids with regards to it ability, when used in conjunction with low concentrations of a surfactant (e.g., 0.05-2.0% w/v), to reduce viable microbe concentrations by greater than 2 log within 5 minutes of exposure.

One aspect of the disclosure, therefore, encompasses embodiments of a method of reducing a microbial population of a liquid, the method comprising contacting the liquid with a microbicidal composition comprising: about 0.5% to about 20% by weight per volume of levulinic acid and about 0.05% to about 5% by weight per volume of sodium dodecyl sulfate (SDS); about 0.5% to about 10% by weight per volume of levulinic acid and about 0.05% to about 3% by weight per volume of sodium dodecyl sulfate (SDS); about 0.5% to about 5% by weight per volume of levulinic acid and about 0.05% to about 2% by weight per volume of sodium dodecyl sulfate (SDS); or about 0.5% to about 3% by weight per volume of levulinic acid and about 0.05% to about 1% by weight per volume of sodium dodecyl sulfate (SDS).

In embodiments of this aspect of the disclosure, the liquid is suitable for consumption by an animal or human.

In some embodiments of this aspect of the disclosure, the liquid can have a pH value between about 0 and about 7.

In some embodiments of this aspect of the disclosure, the liquid is water or a beverage.

In embodiments of this aspect of the disclosure, the beverage is a carbonated beverage.

In some embodiments of this aspect of the disclosure, the beverage is a fruit juice, a vegetable-based beverage, a sugar syrup, a tea, an infusion, a coffee, an isotonic drink, a fermented beverage, or a milk-derived beverage.

In some embodiments of this aspect of the disclosure, the microbicidal composition remain can remain in the liquid after packaging of said liquid.

Another aspect of the present disclosure encompasses embodiments of a method for decontaminating a solid surface of a beverage manufacturing facility, said method comprising the steps of contacting the solid surface with an aqueous composition comprising: about 0.5% to about 20% by weight per volume of levulinic acid and about 0.05% to about 5% by weight per volume of sodium dodecyl sulfate (SDS); about 0.5% to about 10% by weight per volume of levulinic acid and about 0.05% to about 3% by weight per volume of sodium dodecyl sulfate (SDS); about 0.5% to about 5% by weight per volume of levulinic acid and about 0.05% to about 2% by weight per volume of sodium dodecyl sulfate (SDS); or about 0.5% to about 3% by weight per volume of levulinic acid and about 0.05% to about 1% by weight per volume of sodium dodecyl sulfate (SDS).

In embodiments of this aspect of the disclosure, the solid surface can be a surface of beverage processing equipment or a beverage container.

In embodiments of this aspect of the disclosure, the beverage container is selected from the group consisting of: a bottle, a can, a carton, and a bag.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIGS. 1A-1E illustrate bar graphs demonstrating the efficacy of levulinic acid and SDS, alone or in combination, to kill spores of Bacillus anthracis Sterne. Spores were exposed to one of six different solutions: A: 3% levulinic acid plus 2% SDS; B: 2% levulinic acid plus 1% SDS; C, 0.5% levulinic acid plus 0.05% SDS; D: 3% levulinic acid; E: 2% SDS; or F: water (serving as the control) for various lengths of time before testing the spores for viability relative to the control sample. Average plate counts are based on counting three plates; error bars indicate +/−one standard deviation.

Period of exposure: FIG. 1A, 0 min; FIG. 1B, 10 min; FIG. 1C, 45 min; FIG. 1D, 90 min; FIG. 1E, 180 min.

FIGS. 2A-2E illustrate bar graphs demonstrating the efficacy of levulinic acid and SDS, alone or in combination, to kill spores of Bacillus anthracis Sterne. Spores were exposed to one of six different solutions: A: 3% levulinic acid plus 2% SDS; B: 2% levulinic acid plus 1% SDS; C, 0.5% levulinic acid plus 0.05% SDS; D: 3% levulinic acid; E: 2% SDS; and F: water (serving as the control) for time intervals before testing the spores for viability relative to the control sample. In order to differentiate whether CFU originated from vegetative cells or from spores, at each time point samples were split in two equivalent aliquots. One aliquot was subjected to heat treatment (65° C., 30 min) to kill vegetative cells before enumeration of residual heat-resistant spores. The other aliquot was plated at room temperature (RT). Average plate counts are based on counting three plates; error bars indicate +/−one standard deviation.

Period of exposure: FIG. 2A, 0 hr; FIG. 2B, 1 hr; FIG. 2C, 2 hrs; FIG. 2D, 3 hrs; FIG. 2E, 4 hrs.

FIGS. 3A-4E represent bar graphs demonstrating the efficacy of levulinic acid and SDS, alone or in combination, to kill spores of Bacillus anthracis Sterne. Spores were exposed to one of six different solutions: A: 3% levulinic acid plus 2% SDS; B: 2% levulinic acid plus 1% SDS; C, 0.5% levulinic acid plus 0.05% SDS; D: 3% levulinic acid; E: 2% SDS; and F: water (serving as the control) for time intervals before testing the spores for viability relative to the control sample. In order to differentiate whether CFU originated from vegetative cells or from spores, at each time point samples were split in two equivalent aliquots. One aliquot was subjected to heat treatment (65° C., 30 min) to kill vegetative cells before enumeration of residual heat-resistant spores. The other aliquot was plated at room temperature (RT). Average plate counts are based on counting three plates; error bars indicate +/−one standard deviation.

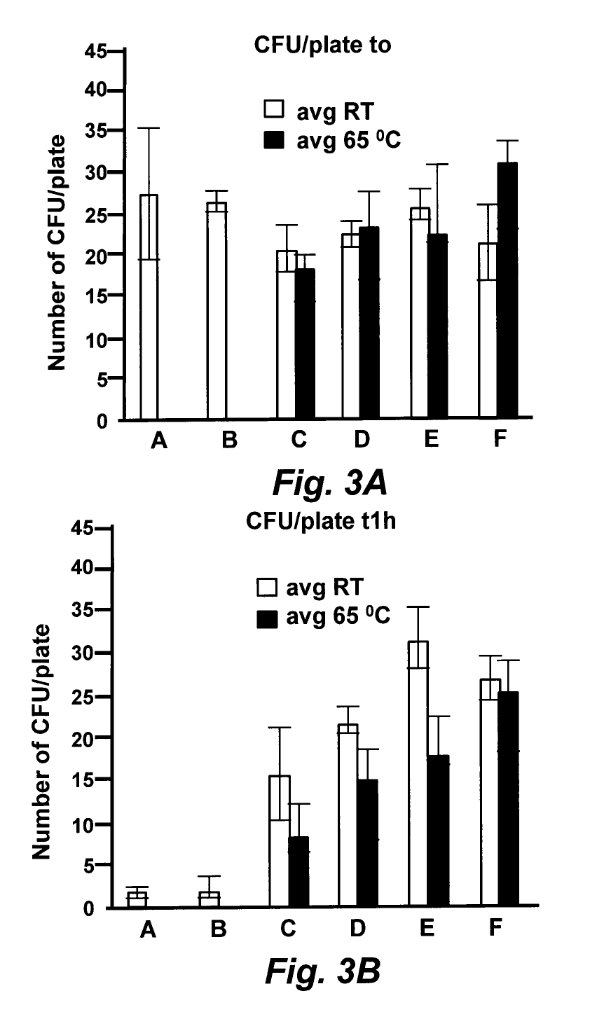

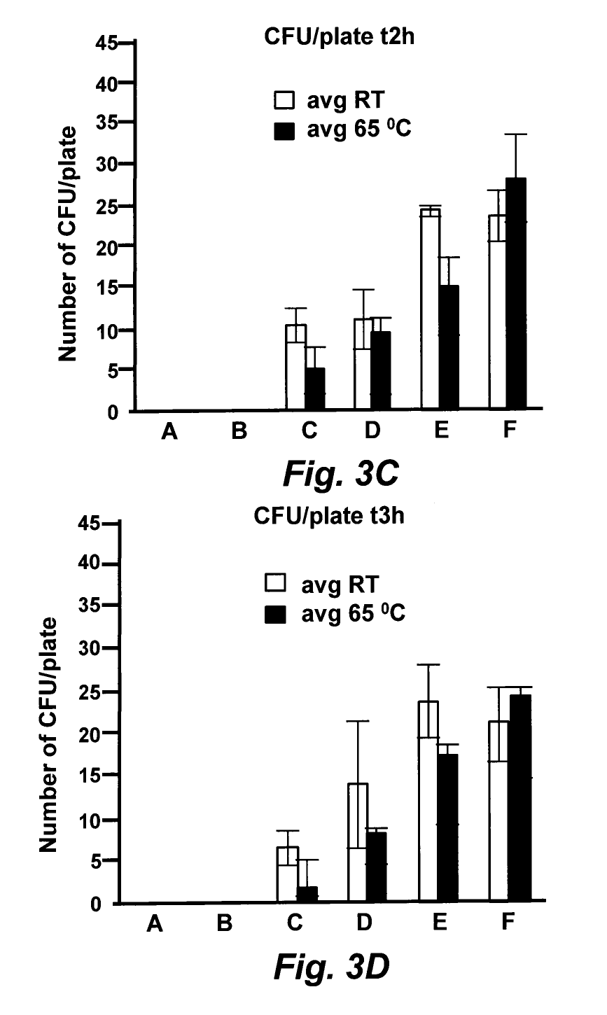

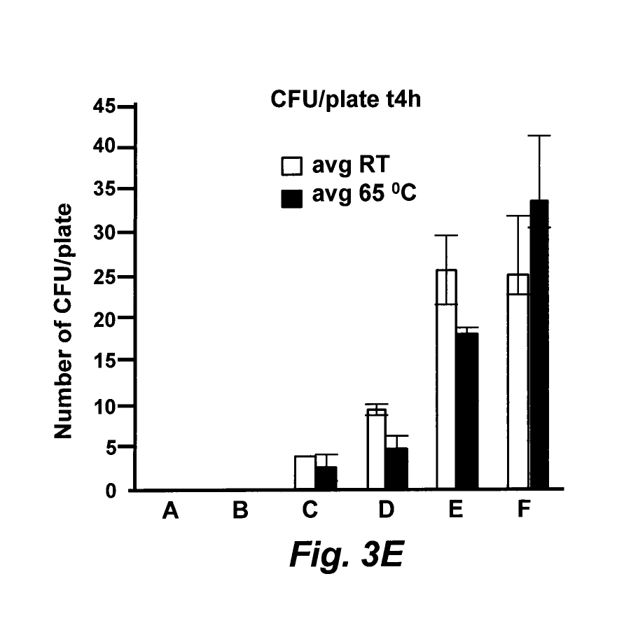

Period of exposure: FIG. 3A, 0 hr; FIG. 3B, 1 hr; FIG. 3C, 2 hrs; FIG. 3D, 3 hrs; FIG. 3E, 4 hrs.

### DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

Prior to describing the various embodiments, the following definitions are provided and should be used unless otherwise indicated.

### DEFINITIONS

In describing and claiming the invention, the following terminology will be used in accordance with the definitions set forth below.

The term “beverage” as used herein refers to any liquid that can be consumed by a human or animal, including, but not limited to, water, tea, coffee, milk-based liquid products, carbonated sodas, non-carbonated beverages such as salt/nutrient replenishment (isotonic) drinks, fruit-based drinks, fermented liquid products including, but not limited to, beers, wines, vinegars, soy sauces, and the like. It is further intended that the compositions and methods of the present disclosure may be used to reduce the microbial colonization or contamination of equipment intended for the preparation, handling and packaging of the liquid, and of packages such as bottles, cans, cartons, and the like that may be used for the storage, transport, or retail of the liquid.

The term “microorganism” or “microbe” as used herein is intended to include living cellular organisms, both unicellular and multicellular that are less than 5 mm in length, and include but are not limited to viruses, bacteria, fungi, archaea, protists; green algae, plankton, amoebas and yeasts (non-filamentous fungi), molds (filamentous fungi), or spores formed by any of these.

As used herein an “antimicrobial” is a compound that exhibits microbicidal or microbistatic properties that enables the compound to kill, destroy, inactivate, or neutralize a microorganism; or to prevent or reduce the growth, ability to survive, or propagation of a microorganism or population of microorganisms.

As used herein the term “acid” refers to any chemical compound that, when dissolved in water, gives a solution with a hydrogen ion activity greater than in pure water, i.e. a pH less than 7.0. An “organic acid” is a carbon containing compound (except for carbonic acid) with acidic properties. A monoprotic acid is an acid that is able to donate one proton per molecule during ionization.

As used herein, the term “pharmaceutically acceptable” is intended to encompass any compound that can be safely administered to or consumed by warm blooded vertebrates including humans, and domesticated and wild mammals. Pharmaceutically acceptable acids and surfactants include acids and surfactants that are classified by the United States Food and Drug Administration (FDA) as being Generally Regarded As Safe (GRAS), and encompass any of the agents approved by a regulatory agency of the US Federal government or listed in the US Pharmacopeia for use in animals, including humans.

As used herein an “effective” amount of an anti-microbial composition refers to a concentration of active agent that provides the desired effect, i.e., a log order reduction in the microbial count in a liquid, or on a hard surface without reducing organoleptic properties of the food substance.

As used herein “organoleptic properties” relating to properties that can be detected by human or animal senses (taste, color, odor, feel) unaided by mechanical and analytical devices.

### DESCRIPTION

There is growing interest in the development of novel antimicrobial treatments such as combinations of natural antimicrobials, including generally recognized as safe (GRAS) chemicals to improve the microbiological safety of consumable food and beverage products. The pharmaceutically acceptable chemical compositions of the disclosure, i.e. compositions that when ingested or received by an animal or human will not cause physiological harm or death of the recipient, have been formulated and have been demonstrated as effective in killing large cell numbers of Salmonella on chicken skin and in chicken processing water, and in killing both Salmonella and E. coli O157:H7 on fresh produce without producing any detectable impact on the organoleptic properties of the treated food. Such compositions are effective against a large spectrum of food borne pathogens, including those that may occur in water, beverages and the like, leading to the reduction of pathogen populations by factors often greater than 7 log. The time needed for reaching such level of pathogen elimination range from a few seconds to about 2 minutes. Compositions of the disclosure have also been shown to be highly efficient in the treatment of pathogen biofilms formed on surfaces of type normally encountered on food manufacturing and processing facilities, including the containers used for storage, dispensation, and marketing.

It has been found that the composition and methods of the present disclosure are advantageous for reducing a microbial contaminant population that may be present in a liquid, or colonizing a hardened surface in contact with the liquid. At the concentrations of levulinic acid and SDS contemplated for use in the methods of the disclosure, not only is there a significant decrease in the viability of microorganisms contacted by the compositions of the disclosure, even in the presence of high loads of organic material, but there is also little, if any, deterioration in the organoleptic properties of the treated liquid. Since treatable liquids are intended for consumption by animals and/or humans, the matter of taste, palatability, and acceptance by the consumer is of major concern.

The compositions of the present disclosure have been shown to be effective in reducing the viability of a broad spectrum of microorganisms, including, but not limited to viruses, bacteria (both sporing and non-sporing), fungi (molds and yeasts), and the like. The compositions may be added to a liquid during the initial collection of the liquid, such as during the extraction of a fruit or vegetable juice, milk, collection of water, etc. It is contemplated that the antimicrobial compositions of the disclosure do not need to be removed from the liquid before, during or after the initial reduction in a microbial viability. The continued presence of the compositions in the liquid or beverage provides the advantage of preventing further contamination of the liquid during storage and without inducing an undesirable change in the organoleptic properties of the liquid.

The antimicrobial compositions provided herein, therefore, comprise a pharmaceutically acceptable acid and a pharmaceutically acceptable surfactant. Surprisingly, the compositions disclosed herein are capable of reducing a microbial population of a liquid or a surface in contact with a microorganism by a factor greater than 10², including by a factor of 10³ to a factor of 10⁸, using a combination of an acid and surfactant at concentrations that are ineffective when used separatedly. The individual active ingredients of the present compositions are ineffective in reducing microbial cell count by a factor greater than 10², even when the active agents are used separately at 2× or 5× the effective concentration used in the combination. The concentration of the pharmaceutically acceptable acid in the antimicrobial compositions of the disclosure is within the range of about 0.03% to about 3%, or about 0.05% to about 2%, or about 0.05% to about 1%, or about 0.1% to about 3%, or about 0.3% to about 3%, or about 0.3% to about 2%, or about 0.5% to about 3%, or about 0.5% to about 2%, or about 0.5% to about 1%, weight per volume in water. In one embodiment the concentration of the pharmaceutically acceptable surfactant in the anitmicrobial composition is within the range of about 0.005% to about 1%, or about 0.01% to about 1%, or about 0.05% to about 1%, or about 0.1% to about 1%, or about 0.05% to about 2%, or about 0.5% to about 2% by weight per volume in water.

Previous studies revealed that combinations of different organic acids can be used as anti-bacterial agents based on their killing effects on E. coli O157:H7 and Campylobacter (Zhao, et al. 2006). Levulinic acid is an organic acid that can be produced cost effectively and in high yield from renewable feedstocks (Bozell, et al. 2000, Fang & Hanna, 2002). Its safety for humans has been widely tested and FDA has given it GRAS status for direct addition to food as a flavoring agent or adjunct (21 CFR, 172.515). As disclosed herein, the antimicrobial effect of 1% by weight levulinic acid alone will not suffice to kill more than 1 log colony-forming unit (CFU) Salmonella/ml within 30 minutes, and its bactericidal effect was increased only to 3.4 log CFU/ml within 30 minutes when its concentration was increased to 3% by weight (see Tables 1-3).

Sodium dodecyl sulfate (SDS) also has GRAS status (21 CFR, 172.210) at 0.5% wt of gelatin, as a whipping agent used in marshmallows and at 0.0125% in liquid and frozen egg whites. It has been widely studied and is used as a surfactant in household products such as toothpastes, shampoos, shaving foams, and bubble baths. The SDS molecule has a tail of 12 carbon atoms attached to a sulfate group, giving the molecule the amphiphilic properties required of a surfactant. As disclosed herein the use of SDS by itself has very little antimicrobial effect.

The substantial bactericidal effect of a combination of levulinic acid and SDS on E. coli O157:H7 and Salmonella was validated on water containing different levels of chicken feces or feathers (see Example 1, Tables 4-7). The bactericidal activity of this combination of chemicals remained effective even in an extreme organic-rich environmental containing fecal matter or feathers.

Spoilage of fruit juices by Alicyclobacillus species, especially by A. acidoterrestris, has become well-recognized since 1982 and is now a beverage industry-wide problem. Beverage spoilage by Alicyclobacillus results in a flat-sour type spoilage, with off-flavor and cloudiness. The production of guaicol and halogenated phenols is responsible for the primary off flavor, characterized as smoky and medicinal. Spores of Alicyclobacillus species can survive heat pasteurization processes applied to fruits, vegetables, fruit/vegetable-based beverages, fruit concentrates and purees, sugar, sugar syrups, tea, isotonic drinks (sports drinks), and other acidic beverage-type products. The heat resistance D₉₅° C. values in juices of Alicyclobacillus spores ranges from 0.06 to 5.3 min, with z-values of 7.2 to 12.8° C. An effective method of reducing the viability of populations of Alicyclobacillii is, therefore, highly desirable.

The efficacy of levulinic acid plus SDS at different concentrations and ratios in inactivating spores of Alicyclobacillus and Bacillus species in liquid preparations. Several isolates of each genus were tested individually. We also determined the inactivation of these spore preparations by levulinic acid plus SDS in combination with a heat treatment of 65° C. for 30 min.

The embodiments of the methods of the present disclosure provide for contacting a beverage having a pH value of less than 7.0 with an antimicrobial composition comprising pharmaceutically acceptable surfactant and a pharmaceutically acceptable organic acid, wherein the concentration of the organic acid is 0.5% by weight/volume or less and the concentration of the surfactant is 0.05% by weight/volume or less. It is desirable, however, that since the antimicrobial compositions of the disclosure are to be effectively used in beverages, including, but not limited to, water that the organic acid be palatable and not leave an unacceptable taste or odor that may not be acceptable to a consumer of the liquid.

The composition comprises a maximum concentration of 0.3 to 3% by weight of one or more organic acids selected from the group consisting of lactic acid, acetic acid, and levulinic acid and a maximum concentration of 0.05 to 2% by weight SDS. In one embodiment the composition comprises 0.3 to 3% by weight levulinic acid and 0.05 to 1% by weight SDS.

The antimicrobial compositions disclosed herein can be used to reduce the population of an undesirable microbe in a liquid such as water or a beverage, including a beverage with significant organic load. A reduction of a population of a microbe can be achieved when the populations of the microbe is reduced by at least 2 log.

An antimicrobial composition comprising levulinic acid and a surfactant is provided wherein the composition is effective in reducing resident microbial populations on food substance. In one embodiment, a food contaminated with 10⁸-10⁹ CFU/ml E. coli O157:H7 can be treated with the antimicrobial compositions disclosed herein to reduce the presence of viable bacteria by a factor greater than 10³ (including reductions of 10⁴, 10⁵, 10⁶ and 10⁷ or even higher) after exposure to said composition for five minutes, under conditions otherwise favorable to proliferation of said E. coli O157:H7. The concentration of said levulinic acid and surfactant are at concentrations that are ineffective in reducing said resident microbial population when used separatedly. The concentration of each of the levulinic acid and surfactant components is at a concentration 0.5×, 0.25×, 0.1×, or less than 0.1×, of the concentration required to produce a significant reduction (e.g., greater than one log reduction within 5 minutes) in an E. coli O157:H7 microbial population when the respective component (i.e., levulinic acid or surfactant) is used separately. In one embodiment the concentration of the levulinic acid in the compositions of the present invention is no more than about 20% to about 0.5% (w/v), about 10% to about 0.5% (w/v), about 5% to about 0.5% (w/v), about 3% to about 0.5% (w/v), about 2.5% to about 0.5% (w/v), about 2.0% to about 0.5% (w/v), about 1.5% to about 0.5% (w/v), about 1.0% to about 0.5% (w/v), about 0.5% or about 0.25% (w/v). In some embodiments the concentration of the levulinic acid is less than 2.5% (w/v) or less than 2.0% (w/v) and in a further embodiment the concentration of the levulinic acids is about 0.5% (w/v) levulinic acid. These concentrations of levulinic acid in combination with a pharmaceutically acceptable surfactant at concentrations of less than 2% have been found to retain the organoleptic properties of foods, including produce. The concentration of the surfactant in one embodiment of the present compositions is no more than about 0.01% to about 1%, or about 0.01% to about 0.1% and more typically is about 0.05% (w/v).

A method for the rapid killing of microbial strains, including bacteria, yeasts, and molds, is provided. The method comprises contacting the beverage with a composition comprising a SDS and levulinic acid, wherein the concentration of the organic acid is about 20.0% to about 0.5%, about 10.0% to about 0.5%, about 5.0% to about 0.5%, about 3.0% to about 0.5%, about 2.0% to about 0.5%, about 1.0% to about 0.5% or about 0.5% (w/v) or less, and the concentration of the surfactant is less than about 5% to about 0.05%, about 0.5% to about 0.05%, 0.1% to about 0.05%, or 0.05% (w/v).

In another aspect of the disclosure, an object in a food processing environment, including, but not limited to, the equipment required for bottling a beverage, or the containers such as bottles, can be treated with the antimicrobial compositions.

Processing equipment is commercially available for washing beverage containers, and applicants have found that the levulinic compositions of the present invention (eg. compositions having a concentration up to 3% levulinic acid) are not corrosive to such equipment. In particular, applicants have found that when using a large stainless steel seed washing unit, not only was the levulinic acid/SDS treatment as effective in killing E. coli O157:H7 as the current industrial standard of 20,000 ppm calcium hypochlorite, but it was not corrosive to the equipment and even removed rust on chains within the unit. Thus the levulinic acid composition served to clean the unit like a detergent without the undesirable corrosive effect on equipment that is associated with many sanitizers such as chlorine. Accordingly, one embodiment of the present invention is also directed to a method of decontaminating equipment and hard surfaces by contacting such equipment and hard surfaces with the levulinic compositions of the present disclosure.

The methods of the disclosure, therefore, comprise contacting the liquid or surface with a composition comprising levulinic acid and SDS, wherein the composition comprises a maximum concentration of 3% by weight levulinic acid and 2% by weight SDS.

The reduction of pathogens, including Salmonella and E. coli O157:H7, spore-forming bacteria, yeasts and molds resulting from the use of the compositions disclosed herein is a log reduction (>5 log/ml or greater within one minute).

In one embodiment the beverage is contacted with the levulinic acid/surfactant containing solution for a predetermined length of time such as about 1, 2, 3, 4, 5 or 10 minutes. Such time intervals have been found to be effective in reducing viable cell counts by at least 3 orders of magnitude. More particularly, applicants have demonstrated that compositions comprising levulinic acid, at a concentration of 3% (w/v) or less, in combination with a surfactant (such as SDS) reduces viable microbe cells counts by a factor of 5 to logs within 1 to 5 minutes of contact under conditions otherwise suitable for microbe growth.

Formulations based on levulinic acid are cheap, easy to produce, do not produce bad odor, are environmentally acceptable, and have been approved for use in food by FDA.

The antimicrobial compositions of the present invention can be used to remove surface microbial contamination from a solid surface, including for example, a beverage processing equipment, bottling machinery, or the receiving containers such as bottles or cans. The method comprises contacting the surface with the antimicrobial composition, optionally in the form of a foamed composition. In one embodiment the biofilm is contacted with an aqueous composition comprising 0.5% to 3% by weight per volume in water of lebulinic acid and 0.05% to 2% by weight per volume in water of an ionic surfactant. In one embodiment the concentration of the levulinic acid is less than 3%, 2.5%, 2.0%, 1.5%, 1.0%, 0.5% or 0.25% (w/v) of the aqueous composition and the concentration of the sodium dodecyl sulfate and/or sodium laureth sulfate is less than 2.0, 1.5, 1.0, 0.5, 0.1 or 0.05% (w/v) of the aqueous composition.

One aspect of the disclosure, therefore, encompasses embodiments of a method of reducing a microbial population of a liquid, the method comprising contacting the liquid with a microbicidal composition comprising: about 0.5% to about 20% by weight per volume of levulinic acid and about 0.05% to about 5% by weight per volume of sodium dodecyl sulfate (SDS); about 0.5% to about 10% by weight per volume of levulinic acid and about 0.05% to about 3% by weight per volume of sodium dodecyl sulfate (SDS); about 0.5% to about 5% by weight per volume of levulinic acid and about 0.05% to about 2% by weight per volume of sodium dodecyl sulfate (SDS); or about 0.5% to about 3% by weight per volume of levulinic acid and about 0.05% to about 1% by weight per volume of sodium dodecyl sulfate (SDS).

In embodiments of this aspect of the disclosure, the liquid is suitable for consumption by an animal or human.

In some embodiments of this aspect of the disclosure, the liquid can have a pH value between about 0 and about 7.

In some embodiments of this aspect of the disclosure, the liquid is water or a beverage.

In embodiments of this aspect of the disclosure, the beverage is a carbonated beverage.

In some embodiments of this aspect of the disclosure, the beverage is a fruit juice, a vegetable-based beverage, a sugar syrup, a tea, an infusion, a coffee, an isotonic drink, a fermented beverage, or a milk-derived beverage.

In some embodiments of this aspect of the disclosure, the microbicidal composition remain can remain in the liquid after packaging of said liquid.

Another aspect of the present disclosure encompasses embodiments of a method for decontaminating a solid surface of a beverage manufacturing facility, said method comprising the steps of contacting the solid surface with an aqueous composition comprising: about 0.5% to about 20% by weight per volume of levulinic acid and about 0.05% to about 5% by weight per volume of sodium dodecyl sulfate (SDS); about 0.5% to about 10% by weight per volume of levulinic acid and about 0.05% to about 3% by weight per volume of sodium dodecyl sulfate (SDS); about 0.5% to about 5% by weight per volume of levulinic acid and about 0.05% to about 2% by weight per volume of sodium dodecyl sulfate (SDS); or about 0.5% to about 3% by weight per volume of levulinic acid and about 0.05% to about 1% by weight per volume of sodium dodecyl sulfate (SDS).

In embodiments of this aspect of the disclosure, the solid surface can be a surface of beverage processing equipment or a beverage container.

In embodiments of this aspect of the disclosure, the beverage container is selected from the group consisting of: a bottle, a can, a carton, and a bag.

The specific examples below are to be construed as merely illustrative, and not limiting of the remainder of the disclosure in any way whatsoever. Without further elaboration, it is believed that one skilled in the art can, based on the description herein, utilize the present disclosure to its fullest extent. All publications recited herein are hereby incorporated by reference in their entirety.

It should be emphasized that the embodiments of the present disclosure, particularly, any “preferred” embodiments, are merely possible examples of the implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure, and the present disclosure and protected by the following claims.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified.

### EXAMPLES

### Example 1

Bactericidal Efficacy of the Organic Acid/SDS Compositions: Five isolates of E. coli O157:H7, including 932 (human isolate), E009 (beef isolate), E0018 (cattle isolate), E0122 (cattle isolate), E0139 (deer jerky isolate); and five isolates of Salmonella typhimurium DT104, including three cattle isolates and two meat isolates; and five isolates of Salmonella enteritidis, including 564-88 (food isolate), 193-88 (human isolate), E39 (egg isolate), 460-88 (egg isolate) and 457-88 (poultry isolate); and five isolates of L. monocytogenes, including LM101 (serotype 4b, salami isolate), LM 112 (serotype 4b, salami isolate), LM113 (serotype 4b, pepperoni isolate), LM9666 (serotype ½c, human isolate), and LM5779 (serotype ½ c, cheese isolate); and one isolate of Yersinia pestis (A1122) were used. Each Salmonella and E. coli O157:H7 strain was grown in tryptic soy broth (TSB) at 37° C. for 18 h then washed in 0.1 M phosphate buffered saline pH 7.2. Approximately equal cell numbers of each of the five strains were combined and used as a 5-strain mixture with cell numbers being adjusted according to the experimental design. Bacterial cell numbers were confirmed by serial dilutions (1:10) in 0.1% peptone and a volume of 0.1 ml from each dilution tube was plated on tryptic soy agar (TSA), XLD agar, and Sorbitol MacConkey agar (SMA), incubated at 37° C. for 24 h, and colonies were counted.

Acetic acid, caprylic acid, lactic acid, levulinic acid and sodium dodecyl sulfate (SDS) were tested alone or as a combination at different concentrations and temperatures (8° C. or 21° C.) for their killing effect on S. enteritidis, S. typhimurium, and E. coli O157:H7 in water or chicken skin contaminated with chicken feces or feathers.

Feces from 5 different chickens and used as a mixture. Feathers were obtained from a slaughterhouse. Chicken and poultry wings were purchased from a slaughter plant or local retail store and skin was separated immediately before use. Only Salmonella-negative chicken feces, feather, skin, or poultry wing samples were used for the experiments. A volume of 10 ml of deionized water and 1.0 g feces, or feathers, or a piece of skin (5×5 cm²) was added to a Whirl-Pak bag. Each bag of feces, feather, or skin sample was pummeled in a stomacher blender at 150 rpm for 1 min. The bag of poultry wing was massaged by hands for 1 min. The fluid was serially (1:10) diluted in 0.1% peptone and 0.1 ml from each dilution tube was plated in duplicate on XLD plates to determine if these samples were contaminated with salmonellae. Enumeration of S. enteritidis, S. typhimurium DT104 and E. coli O157:H7: At each sampling time, 1.0 ml of the treated bacterial suspension was mixed with 9.0 ml of neutralizing buffer or PBS (depending on the pH). The solution was serially (1:10) diluted in 0.1% peptone water and 0.1 ml of each dilution was surface-plated onto TSA and XLD, or TSA and XLD containing ampicillin (32 mg/ml), tetracycline (16 mg/ml) and streptomycin (64 mg/ml) (TSA+, XLD+), or TSA and Sorbitol MacConkey agar plates in duplicate. The plates were incubated at 37° C. for 48 h. Colonies typical of Salmonella or E. coli O157:H7 were randomly picked from plates with the highest dilution for confirmation of Salmonella or E. coli by biochemical tests and for confirmation of serotyping by latex agglutination assay. When Salmonella or E. coli O157:H7 were not detected by direct plating, a selective enrichment in universal pre-enrichment broth (UPB) was performed by incubating 25 ml of treatment suspension in a 500-ml flask containing 225 ml of UPB for 24 h at 37° C. Following pre-enrichment, 1 ml was transferred to 10 ml of selenite cystine broth and incubated for 24 h at 37° C. Following incubation, a 10-μl loopful from the broth tube was plated in duplicate onto XLD plates, and incubated for 24 h at 37° C.

Colonies with typical Salmonella spp. morphology were selected and transferred one more time on XLD plates and incubated for 24 h at 37° C. All presumptive Salmonella isolates were tested by the Salmonella latex agglutination assay. Isolates positive for Salmonella by the latex agglutination assay were tested with the API 20E assay for biochemical characteristics for the identification of Salmonella. Studies with all chemical treatments were done in duplicate or triplicate, two replicates were plated per sample and results were reported as means.

Determination of Salmonella inactivation in water contaminated with chicken feathers or feces: The protocols used were the same as described previously (Zhao, et al. 2006), with minor modifications. Chicken feathers or feces were weighed and added into a glass beaker containing chemicals to be determined according to different ratios (w/v) in a glass beaker and mixed by a magnetic bar with agitation at 150 rpm. A 5-strain mixture of S. enteritidis was added. A volume of 1 ml sample was removed and serially diluted (1:10) in PBS. The aerobic bacterial and Salmonella counts were determined according to the procedures we described above.
Results: Determination of Salmonella inactivation in water with 0.1 to 2.0% by weight levulinic acid revealed about a 1-log CFU/ml reduction. Its killing effect was greater when the levulinic acid concentration was increased to 3.0% by weight, resulting in a 3.4-log Salmonella/ml reduction when in contact for 30 minutes (Table 1). Treatments of 0.5% by weight acetic acid and 0.5% by weight lactic acid for 30 minutes reduced Salmonella cell numbers by 0.7- and 2.0-log CFU/ml, respectively. A treatment of 0.05% by weight SDS for 30 minutes did not reduce Salmonella cell numbers (Table 1).

All the combinations of organic acids evaluated in combination with 0.03-0.05% by weight SDS were effective, at different degrees, in killing Salmonella, with the population of Salmonella quickly reduced from 10⁷ CFU/ml to undetectable (enrichment-negative) with a contact time of 5-10 seconds (see Table 1).

Neither levulinic acid at 0.5% by weight nor SDS at 0.05% by weight when applied individually provided a significant killing effect on either E. coli O157:H7 or S. typhimurium DT 104; however, the combination of levulinic acid and SDS at these concentrations reduced E. coli O157:H7 and S. typhimurium cell numbers by 7 log CFU/ml within 1 min (see Tables 2 and 3).

The levulinic acid and SDS treatment to kill S. enteritidis was further tested in water containing chicken feathers or feces. Results revealed that feather contamination did not reduce the killing effect of that treatment, whereas the presence of chicken feces did. S. enteritidis was reduced from 7.6 log CFU/ml to 1.2 log CFU/ml in chicken feces contaminated water after 2 min exposure, but was not detected (7.6 log CFU/ml reduction) after 5 min (P<0.05; Table 4). Greater concentrations of levulinic acid and SDS were more effective in killing Salmonella, even in water heavily contaminated with chicken feces (1 part feces: 20 parts water; wt/v) (Table 4).

Aerobic bacteria counts in water contaminated with chicken feces at a ratio of 1:100 (w/v) were reduced by >4.0 log CFU/ml after treatment with 1% by weight levulinic acid and 0.1% by weight SDS for 2 min. The antimicrobial effect was increased to ca. 5.5 log CFU/ml reduction in water contaminated with chicken feces at a ratio of 1:20 (w/v) when the chemical concentrations were increased to 3% by weight levulinic acid plus 2.0% by weight SDS for 2 min (Table 5).

In one embodiment the chemical combination comprises 45 mM levulinic acid and 1.73 mM SDS, which can rapidly (within 8 seconds) kill up to 7 log of pathogens, including Yersinia pestis, Salmonella enteritidis, S. typhimurium DT104, Listeria monocytogenes, and Escherichia coli O157:H7. This chemical combination is stable at room temperature and environmentally friendly. There is no apparent organoleptic difference between fresh produce treated with this chemical solution for up to 60 mins and fresh produce treated with water or without treatment.

TABLE 1
Reduction of S. enteritidis in water treated with organic acids and
SDS at 21° C.

| | S. enteritidis counts | | | | | |
|---|---|---|---|---|---|---|
| | (log CFU/ml) at mins: | | | | | |
| Chemical Treatment | 0 | 2 | 5 | 10 | 20 | 30 |
| S. enteritidis only (pH 6.7) (Control) | 7.2 | 7.0 | 7.1 | 7.2 | 7.0 | 7.2 |
| 0.1% levulinic acid (pH 2.5) | 7.1 | 7.1 | 6.9 | 7.0 | 6.9 | 6.9 |
| 0.5% levulinic acid (pH 2.6) | 7.1 | 6.8 | 6.9 | 6.9 | 6.6 | 6.7 |
| 1.0% levulinic acid (pH 2.9) | 6.9 | 6.7 | 6.8 | 6.9 | 6.9 | 6.7 |
| 1.5% levulinic acid (pH2.8) | 6.7 | 6.7 | 6.8 | 6.7 | 6.4 | 6.5 |
| 2.0% levulinic acid (pH 2.8) | 6.7 | 6.7 | 6.7 | 6.8 | 6.5 | 6.0 |
| 2.5% levulinic acid (pH 2.6) | 6.9 | 6.8 | 6.9 | 6.4 | 5.8 | 4.8 |
| 3.0% levulinic acid (pH 2.7) | 6.6 | 6.8 | 6.5 | 6.2 | 5.1 | 3.8 |
| 0.5% acetic acid (pH 3.1) | 7.1 | 7.0 | 6.8 | 6.7 | 6.6 | 6.5 |
| 0.5% lactic acid (pH 2.6) | 6.5 | 6.1 | 5.9 | 5.8 | 5.5 | 5.2 |
| 0.05% sodium dodecyl sulfate (pH 4.4) | 7.1 | 7.0 | 7.2 | 7.1 | 7.2 | 7.1 |
| 0.3% levulinic acid + 0.05% SDS | −^{a} | − | − | − | − | − |
| (pH 3.1) | | | | | | |
| 0.4% levulinic acid + 0.05% SDS | − | − | − | − | − | − |
| (pH 2.9) | | | | | | |
| 0.5% levulinic acid + 0.05% SDS | − | − | − | − | − | − |
| (pH 3.0) | | | | | | |
| 0.5% levulinic acid + 0.03% SDS | − | − | − | − | − | − |
| (pH 3.0) | | | | | | |
| 0.05% caprylic acid + 0.03% SDS | − | − | − | − | − | − |
| (pH 3.4) | | | | | | |
| 0.05% caprylic acid + 0.05% SDS | − | − | − | − | − | − |
| (pH 3.2) | | | | | | |
| 0.5% acetic acid + 0.05% SDS (pH 3.0) | − | − | − | − | − | − |
| 0.5% lactic acid + 0.05% SDS (pH 2.5) | − | − | − | − | − | − |

^{a}−, negative by enrichment culture.

TABLE 2
Reduction of E. coli O157:H7 in water treated with levulinic acid and
SDS at 21° C.

| | E. coli O157:H7 counts | | | | | | | |
|---|---|---|---|---|---|---|---|---|
| | (log CFU/ml) at min: | | | | | | | |
| Chemical Treatment | 0 | 1 | 2 | 5 | 10 | 20 | 30 | 60 |
| E. coli O157:H7 only (Control) | 7.1 | 7.2 | 7.0 | 7.2 | 7.1 | 7.1 | 7.2 | 7.2 |
| 0.5% levulinic acid-(pH 3.0) | 7.0 | 6.7 | 6.8 | 6.7 | 6.9 | 6.8 | 6.8 | 6.4 |
| 0.05% SDS-(pH 7.0) | 7.1 | 6.9 | 7.1 | 7.0 | 6.9 | 6.9 | 7.1 | 7.0 |
| 0.5% levulinic acid + 0.05% | −^{a} | − | − | − | − | − | − | − |
| SDS-(pH 3.0) | | | | | | | | |

^{a}−, negative by enrichment culture

TABLE 3
Reduction of S. typhimurium DT 104 in water treated with levulinic
acid + SDS at 21° C.

| | S. typhimurium DT 104 counts | | | | | | | |
|---|---|---|---|---|---|---|---|---|
| | (log CFU/ml) at min: | | | | | | | |
| Chemical Treatment | 0^{a} | 1 | 2 | 5 | 10 | 20 | 30 | 60 |
| S. typhimurium only (Control) | 6.9 | 7.0 | 7.0 | 7.0 | 7.0 | 6.9 | 7.0 | 7.0 |
| 0.5% levulinic acid (pH 3.0) | 6.8 | 6.7 | 6.6 | 6.5 | 6.7 | 6.6 | 6.4 | 5.9 |
| 0.05% SDS (pH 7.0) | 7.0 | 7.0 | 6.8 | 6.9 | 6.8 | 6.9 | 6.9 | 6.9 |
| 0.5% levulinic acid + 0.05% SDS | +^{a} | −^{b} | − | − | − | − | − | − |
| (pH 3.0) | | | | | | | | |

^{a}+, positive by enrichment (minimum detection level is 0.7 log CFU/ml)
^{b}−, negative by enrichment culture

TABLE 4
S. enteritidis counts for treatment of levulinic acid plus SDS in water
containing chicken feathers or feces at 21° C.

| | S. enteritidis counts (log CFU/ml) at | | | | | |
|---|---|---|---|---|---|---|
| | min: | | | | | |
| Treatment | 0 | 2 | 5 | 10 | 20 | 30 |
| In water containing chicken | | | | | | |
| feathers (1:100 w/v) | | | | | | |
| S. enteritidis (pH 6.7) only | 7.5 | 7.7 | 7.4 | 7.5 | 7.6 | 7.6 |
| 1.0% levulinic acid + 0.1% | <0.7 | <0.7 | <0.7 | <0.7 | <0.7 | <0.7 |
| SDS (pH 3.2) | | | | | | |
| In water containing chicken | | | | | | |
| feces (1:100 w/v) | | | | | | |
| S. enteritidis only (pH 6.8) | 7.6 | 7.5 | 7.5 | 7.6 | 7.5 | 7.6 |
| 1.0% levulinic acid + 0.1% | 4.9 | 1.2 | <0.7 | <0.7 | <0.7 | <0.7 |
| SDS (pH 4.0) | | | | | | |
| In water containing chicken | | | | | | |
| feces (1:20 w/v) | | | | | | |
| S. enteritidis only (pH 6.7) | 7.7 | 7.8 | 7.7 | 7.7 | 7.7 | 7.6 |
| 3.0% levulinic acid + 2.0% | <0.7 | <0.7 | <0.7 | <0.7 | <0.7 | <0.7 |
| SDS (pH 4.0) | | | | | | |

<0.7: Minimum detection level by direct plating method

TABLE 5
Aerobic bacteria counts for treatment of levulinic acid plus SDS in water
containing chicken feces at 21° C.

| | Bacteria counts (log CFU/ml) at min: | | | | | |
|---|---|---|---|---|---|---|
| Treatment | 0 | 2 | 5 | 10 | 20 | 30 |
| In water containing chicken | | | | | | |
| feces (1:100, w/v) | | | | | | |
| Aerobic bacteria only | 7.4 | ND^{a} | ND | 7.4 | 7.4 | 7.4 |
| 1.0% levulinic acid + 0.1% | 5.0 | 3.0 | 2.9 | 2.9 | 2.0 | 2.0 |
| SDS (pH 4.0) | | | | | | |
| In water containing chicken | | | | | | |
| feces (1:20, w/v) | | | | | | |
| Aerobic bacteria only | 10.4 | 10.4 | 10.3 | 10.4 | 10.4 | 10.4 |
| 3.0% levulinic acid + 2.0% | 4.5 | 4.9 | 5.1 | 4.9 | 5.1 | 5.1 |
| SDS (pH 4.0) | | | | | | |

^{a}ND, Not determined.

TABLE 6
Effect of 0.5% levulinic acid and 0.05% SDS, pH 3.1 at 21° C. on bacterial species
(ND = Not Determined; a dash “—” indicates “not detected”)

| | Bacterial counts (log CFU/ml) at min: | | | | | | | |
|---|---|---|---|---|---|---|---|---|
| Bacterial Name | 0^{a} | 1 | 2 | 5 | 10 | 20 | 30 | 60 |
| Klebsiella pneumonia in 0.1M PBS | ND^{b} | ND | ND | 6.5 | ND | ND | ND | 6.6 |
| (Control) | | | | | | | | |
| K. pneumonia in 0.5% levulinic acids + | —^{c} | — | — | — | — | — | — | — |
| 0.05% SDS (pH 3.1) | | | | | | | | |
| Hafinia alvei in 0.1M PBS (control) | ND | ND | ND | 6.9 | ND | ND | ND | 6.9 |
| H. alvei in 0.5% levulinic acids + | — | — | — | — | — | — | — | — |
| 0.05% SDS (pH 3.1) | | | | | | | | |
| Klebsiella oxytoca in 0.1M PBS | ND | ND | ND | 7.2 | ND | ND | ND | 7.1 |
| (Control) | | | | | | | | |
| K. oxytoca in 0.5% levulinic acids + | — | — | — | — | — | — | — | — |
| 0.05% SDS (pH 3.1) | | | | | | | | |
| Proteus hauseri in 0.1M PBS | ND | ND | ND | 7.3 | ND | ND | ND | 7.4 |
| (Control) | | | | | | | | |
| Pr. hauseri in 0.5% levulinic acids + | — | — | — | — | — | — | — | — |
| 0.05% SDS (pH 3.1) | | | | | | | | |
| Serratia marcesens in 0.1M PBS | ND | ND | ND | 7.3 | ND | ND | ND | 7.3 |
| (Control) | | | | | | | | |
| Ser. marcesens in 0.5% levulinic | — | — | — | — | — | — | — | — |
| acids + 0.05% SDS (pH 3.1) | | | | | | | | |
| Shigella flexneri in 0.1M PBS | ND | ND | ND | 7.1 | ND | ND | ND | 7.1 |
| (Control) | | | | | | | | |
| Shi. flexneri in 0.5% levulinic acids + | — | — | — | — | — | — | — | — |
| 0.05% SDS (pH 3.1) | | | | | | | | |
| Shi. sonnei in 0.1M PBS (Control) | ND | ND | ND | 7.3 | ND | ND | ND | 7.3 |
| Shi. sonnei in 0.5% levulinic acids + | — | — | — | — | — | — | — | — |
| 0.05% SDS (pH 3.1) | | | | | | | | |
| Staphylococcus aureus in 0.1M | ND | ND | ND | 6.9 | ND | ND | ND | 6.9 |
| PBS (Control) | | | | | | | | |
| Staph. aureus in 0.5% levulinic | — | — | — | — | — | — | — | — |
| acids + 0.05% SDS (pH 3.1) | | | | | | | | |
| Aerococcus viridans in 0.1M PBS | ND | ND | ND | 6.0 | ND | ND | ND | 6.0 |
| (control) | | | | | | | | |
| Aero. viridans in 0.5% levulinic acids + | — | — | — | — | — | — | — | — |
| 0.05% SDS (pH 3.1) | | | | | | | | |
| Yersinia pseudotubersulosis in 0.1M | ND | ND | ND | 7.0 | ND | ND | ND | 7.0 |
| PBS (control) | | | | | | | | |
| Y. pseudotubersulosis in 0.5% | — | — | — | — | — | — | — | — |
| levulinic acids + 0.05% SDS | | | | | | | | |
| (pH 3.1) | | | | | | | | |
| E. coli O26:H11 in 0.1M PBS | ND | ND | ND | 7.2 | ND | ND | ND | 7.2 |
| (Control) | | | | | | | | |
| E. coli O26:H11 in 0.5% levulinic | — | — | — | — | — | — | — | — |
| acids + 0.05% SDS (pH 3.1) | | | | | | | | |
| E. coli O111:NM in 0.1M PBS | ND | ND | ND | 7.1 | ND | ND | ND | 7.1 |
| (Control) | | | | | | | | |
| E. coli O111:NM in 0.5% levulinic | — | — | — | — | — | — | — | — |
| acids + 0.05% SDS (pH 3.1) | | | | | | | | |
| Vibrio chloerae in 0.1M PBS | ND | 5.1 | 5.0 | ND | ND | ND | 4.2 | ND |
| (control) | | | | | | | | |
| V. chloerae in 0.5% levulinic acids + | — | — | — | — | — | — | — | — |
| 0.05% SDS (pH 3.1) | | | | | | | | |
| Campylobacter jejuni in 0.1M PBS | 8.2 | 8.3 | 8.1 | 8.0 | 8.4 | 8.1 | 8.2 | 8.4 |
| (control) | | | | | | | | |
| Camp. jejuni in 0.5% levulinic acids + | <0.7 | <0.7 | <0.7 | <0.7 | <0.7 | <0.7 | <0.7 | <0.7 |
| 0.05% SDS (pH 3.1) | | | | | | | | |

^{a}Initial inoculation level: Hafinia alvei: 1.9 × 10⁸ CFU/ml; Klebsiella oxytoca: 2.1 × 10⁹ CFU/ml; Proteus hauseri: 1.3 × 10⁹ CFU/ml; Serratia marcesens: 1.2 × 10⁹ CFU/ml; Shigella flexneri: 1.1 × 10⁹ CFU/ml; Shigella sonnei: 1.3 × 10⁹ CFU/ml; Staphylococcus aureus: 1.9 × 10⁸ CFU/ml; Aerococcus virians: 1.0 × 10⁸ CFU/ml; Yersinia pseudotuberculosis: 1.0 × 10⁹ CFU/ml; E. coli O26:H11: 1.2 × 10⁹ CFU/ml; E. coli O111:NM: 1.1 × 10⁹; Vibrio cholerae: 1.2 × 10⁶ CFU/ml; Campylobacter jejuni: 1.2 × 10¹⁰ CFU/ml.
^{b}The actual time 0 was delayed by 5 to 10 seconds due to time for sample processing.
^{c}ND, not determined.
^{d}Negative by direct plating and enrichment culture.

### Example 2

Efficacy of the Organic Acid/SDS Compositions against L. monocytogenes: The efficacy of the antibacterial compositions disclosed herein was tested against Listeria monocytogenes using the same assay and procedures disclosed in Example 1. The results are indicated in Table 7.

TABLE 7
Reduction of L. monocytogenes by levulinic acid and SDS individually, and in combination at 21° C.

| | L. monocytogenes counts (log CFU/ml) at min: | | | | | |
|---|---|---|---|---|---|---|
| Chemical Treatment | 0^{a} | 2 | 5 | 10 | 20 | 30 |
| 0.5% levulinic acid (pH 3.1) | 6.7 ± 0.2 | 6.7 ± 0.1 | 6.8 ± 0.3 | 6.9 ± 0.2 | 6.7 ± 0.2 | 6.8 ± 0.2 |
| 1.0% levulinic acid (pH 3.0) | 6.8 ± 0.3 | 6.7 ± 0.2 | 6.6 ± 0.3 | 6.6 ± 0.3 | 6.6 ± 0.0 | 6.6 ± 0.3 |
| 1.5% levulinic acid (pH2.9) | 6.9 ± 0.1 | 6.9 ± 0.2 | 6.9 ± 0.3 | 6.9 ± 0.1 | 6.9 ± 0.3 | 6.8 ± 0.3 |
| 2.0% levulinic acid (pH 2.9) | 6.8 ± 0.3 | 6.8 ± 0.2 | 6.9 ± 0.2 | 6.7 ± 0.2 | 6.9 ± 0.2 | 6.8 ± 0.2 |
| 0.05% sodium dodecyl sulfate | 6.6 ± 0.3 | 6.4 ± 0.1 | 6.0 ± 0.1 | 5.0 ± 0.3 | 3.8 ± 0.2 | 3.3 ± 0.1 |
| (pH 4.8) | | | | | | |
| 0.5% levulinic acid + 0.05% SDS | −^{c} | − | − | − | − | − |
| (pH 3.0) | | | | | | |

^{a}The actual time 0 was delayed by 5 to 10 seconds due to time for sample processing.
^{b}+, Positive by enrichment culture but not by direct plating (minimum detection level is 0.7 log CFU/ml).
^{c}−, Negative by direct plating and enrichment culture.

### Example 3

Reduction of microorganisms by different chemical combination at 21° C.: Different combinations of pharmaceutically acceptable acids in combination with various pharmaceutically acceptable surfactants were tested for their antibacterial properties.

Microorganisms were contacted with the test compositions using the same assay and procedures as disclosed in Example 10. The results obtained by contacting microorganisms with different surfactant/acid combinations are indicated in Tables 8 and 9. As indicated by the following data, particularly Table 9, not all organic acids/surfactant combinations perform equivalently with regards to their efficacy as antimicrobial agents.

TABLE 8
Reduction of microorganisms by different chemical combination at 21° C.

| Chemical treatment | 0^{a} | 1 | 2 | 5 | 10 | 20 | 30 | 60 |
|---|---|---|---|---|---|---|---|---|
| | E. coli O157:H7 counts (log CFU/ml) at min: | | | | | | | |
| E. coli O157:H7 only (Control) | 7.2 | 7.4 | ND^{b} | 7.3 | ND | ND | 7.3 | 7.4 |
| 0.05% SDS to pH 3.0 by 1N HCl | <0.7 | <0.7 | <0.7 | <0.7 | <0.7 | <0.7 | <0.7 | <0.7 |
| | S. enteritidis counts (log CFU/ml) at min: | | | | | | | |
| S. enteritidis only (Control) | 7.2 | 7.1 | ND | 7.2 | ND | ND | 7.4 | 7.3 |
| 0.05% SDS to pH 3.0 by 1N HCl | <0.7 | <0.7 | <0.7 | <0.7 | <0.7 | <0.7 | <0.7 | <0.7 |
| | Y. pestis counts (log CFU/ml) at min: | | | | | | | |
| Y. pestis only (Control) | 6.3 | 6.1 | 6.4 | 6.7 | 6.6 | 6.5 | 6.7 | 6.7 |
| 0.5% Levulinic acid plus | <0.7 | <0.7 | <0.7 | <0.7 | <0.7 | <0.7 | <0.7 | <0.7 |
| 0.05% SDS (pH 3.0) | | | | | | | | |

^{a}The actual time 0 was delayed by 5 to 10 seconds due to time for sample processing.
^{b}ND, not determined.
^{a}The actual time 0 may was delayed by 10 to 20 seconds due to time for sample processing.
^{b}+, Below the minimum detection level by direct plating (<0.7 log CFU/ml), but positive by enrichment culture.

### Example 4

Treatment of Biofilms with Compositions Comprising an Acid and Surfactant
Preparation of stainless steel coupons: Coupons (4 cm×2.5 cm) composed of different materials, including stainless steel, polyvinyl chloride, nitrile rubber, glass, ultra-high molecular weight polyethylene were washed by a 10 min immersion with agitation (150 rpm) in 1000 ml of an aqueous 2% RBS 35 Detergent Concentrate solution (20 ml of RBS 35 Concentrate per liter of tap water at 50° C.; Pierce, Rockford, Ill.), and rinsed by immersion in 1000 ml of tap water (initial at 50° C.) with agitation (150 rpm) for 25 min. Five additional 1-min immersions with agitation (150 rpm) in 1000 ml of distilled water at ambient temperature were performed. The coupons were dried. The coupons were then individually wrapped and autoclaved at 121° C. for 30 min.
Biofilm formation of S. enteritidis on coupons: For purpose of a well-formatted biofilm of S. enteritidis on the surface of coupons, the coupons were placed individually in a 250-ml flask containing 100 ml tryptic soy broth (TSB) and an inoculum of 1.0 ml ca. 10⁸ CFU of a 5-strain mixture of S. enteritidis was added. The flasks were incubated at 37° C. for 24 h. The coupons then were removed individually and placed on the surface of a layer of paper tower for absorbing the extra fluid of the surface.

The coupons having the formed biofilms were then individually transferred to plates containing 30 ml chemical solution for treatment for 0, 1, 2, 5, 10, 20 min. Following treatment each coupon was placed in a 50-ml centrifuge tube containing 9.0 ml of PBS and 30 glass beads (5 mm). The tubes were agitated by a Vortex for 2 min to suspend the adherent bacteria. The suspended bacteria were serially diluted (1:10) in 0.1% peptone and plated in duplicate on TSA and XLD agar plates for S. enteritidis enumeration. The plates were incubated for 48 h at 37° C. and bacterial colonies counted.

Studies of S. enteritidis attached to the surface of the coupons revealed that the pathogen was eliminated in less than 1 minute by the treatment solution containing 3% levulinic acid plus 2% SDS (Tables 9 and 10).

TABLE 9
Reduction of S. enteritidis on stainless steel coupons by levulinic acid
plus SDS at 21° C.

| Treatment | 0^{a} | 1 | 2 | 5 | 10 | 20 |
|---|---|---|---|---|---|---|
| | S. enteritidis counts (log CFU/cm²) with | | | | | |
| | coupons incubated for 2 h at min: | | | | | |
| PBS (7.2) (Control) | 7.4 | 7.3 | ND^{b} | 7.3 | ND | 7.4 |
| 3% levulinic acid + 2% SDS | <0.7 | <0.7 | <0.7 | <0.7 | <0.7 | <0.7 |
| (pH 2.7) | S. enteritidis counts (log CFU/cm²) with | | | | | |
| | coupons incubated for 4 h at min: | | | | | |
| | <0.7 | <0.7 | <0.7 | <0.7 | <0.7 | <0.7 |
| | S. enteritidis counts (log CFU/cm²) with | | | | | |
| | coupons incubated for 24 h at min: | | | | | |
| | <0.7 | <0.7 | <0.7 | <0.7 | <0.7 | <0.7 |

^{a}The actual time 0 may was delayed by 15 to 25 seconds due to time for sample processing
^{b}Not determined

TABLE 10
Inactivation of S. enteritidis in biofilm at 21°
by 3% levulinic acid plus 2% SDS

| | | S. enteritidis count | | | |
|---|---|---|---|---|---|
| | | (log CFU/cm²) at min: | | | |
| Coupon | Treatment Solution | 0 | 1 | 5 | 10 |
| Stainless | PBS, pH 7.2 | 8.0 | 8.4 | 8.6 | 8.2 |
| | NaClO₂ (500 ppm), pH 2.8 | 7.5 | 5.9 | 5.4 | 6.2 |
| | 3.0% levulinic acid (LV) | <0.7 | <0.7 | <0.7 | <0.7 |
| | plus 2.0% SDS, pH 3.0 | | | | |
| Polyvinyl | PBS | 8.8 | 9.0 | 8.8 | 8.0 |
| chloride | NaClO₂ (500 ppm) | 6.9 | 5.5 | 5.3 | 4.2 |
| | 3.0% LV plus 2.0% SDS | 2.3 | 1.7 | 2.2 | <0.7 |
| Nitrile rubber | PBS | 7.8 | 8.0 | 7.7 | 7.9 |
| | NaClO₂ (500 ppm) | 7.2 | 5.2 | 2.6 | 1.3 |
| | 3.0% LV plus 2.0% SDS | 4.1 | 1.7 | <0.7 | <0.7 |
| Glass | PBS | 8.2 | 8.7 | 8.4 | 8.4 |
| | NaClO₂ (500 ppm) | 6.8 | 3.3 | <0.7 | <0.7 |
| | 3.0% LV plus 2.0% SDS | <0.7 | <0.7 | <0.7 | <0.7 |
| Ultra-high | PBS | 8.4 | 8.4 | 8.4 | 8.4 |
| molecular | NaClO₂ (500 ppm) | 6.8 | 6.1 | <0.7 | <0.7 |
| weight | 3.0% LV plus 2.0% SDS | <0.7 | <0.7 | <0.7 | <0.7 |
| polyethylene | | | | | |

### Example 5

Efficacy of compositions to kill spores of Bacillus anthracis Sterne: For all experiments an equal volume of spore suspension of B. anthracis Sterne (34F₂) was added to 25 ml of reagents A, B, C, D, E, and F in 250-ml flasks. The compositions of reagents are A: 3% levulinic acid plus 2% SDS; B: 2% levulinic acid plus 1% SDS; C, 0.5% levulinic acid plus 0.05% SDS; D: 3% levulinic acid; E: 2% SDS; F: water (control).

Flasks were incubated at 37° C. in a shaker (200 rpm). At each time point 100 μl of sample was transferred into 900 μl water, vortexed, and 100 μl of the dilution spread on Brain Heart Infusion agar plates. Plates were incubated at 37° C. overnight and colonies counted the next morning (approximately 16 hours later).

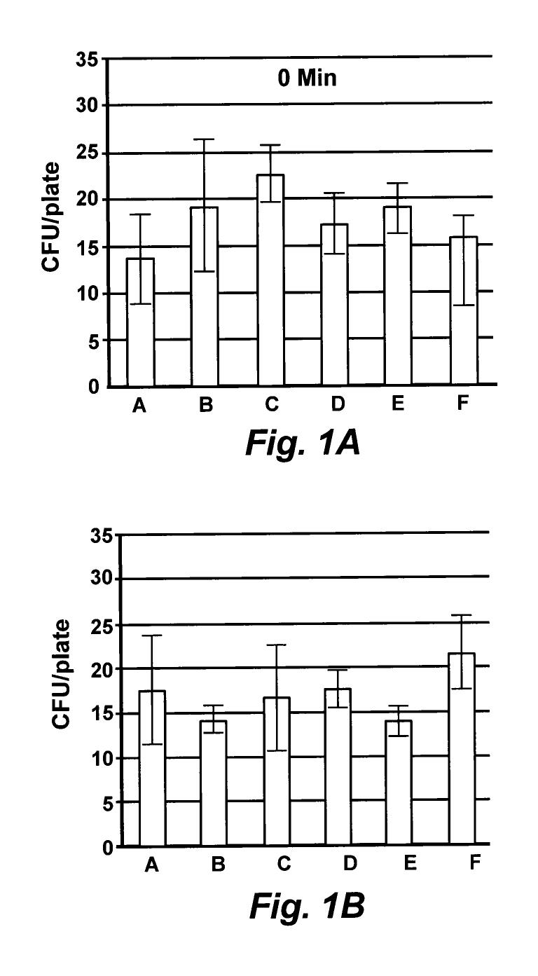

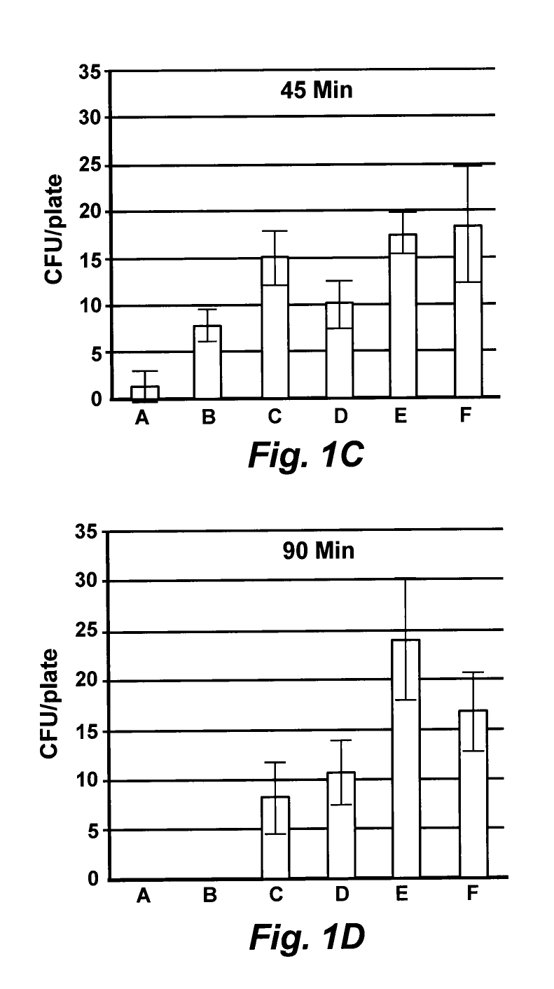

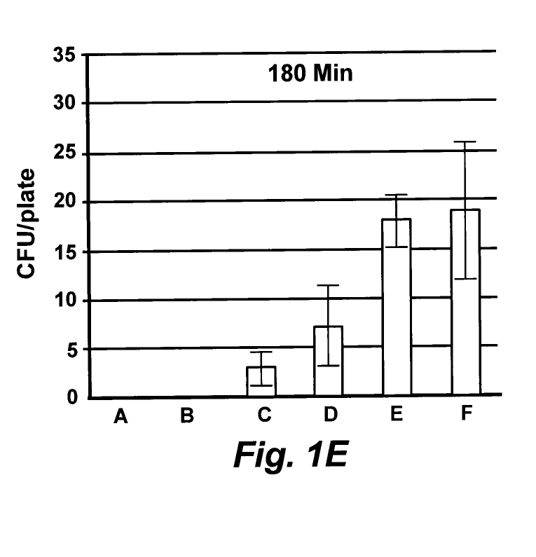

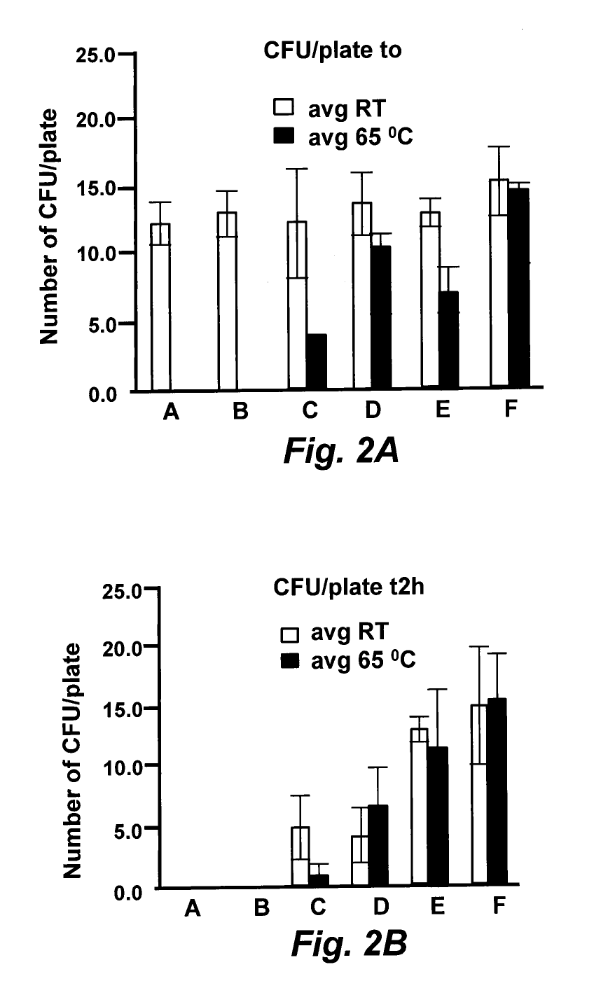

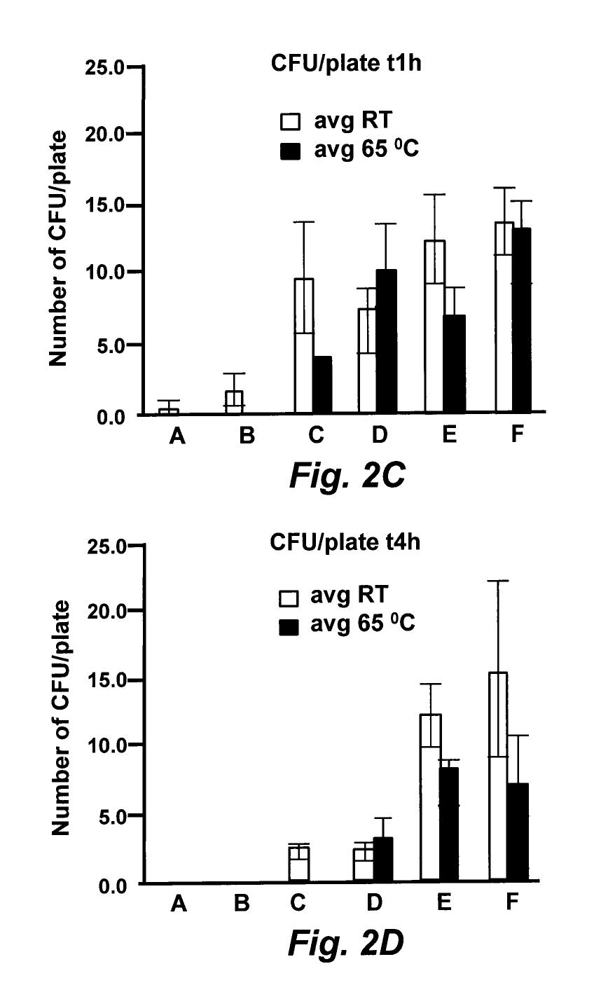

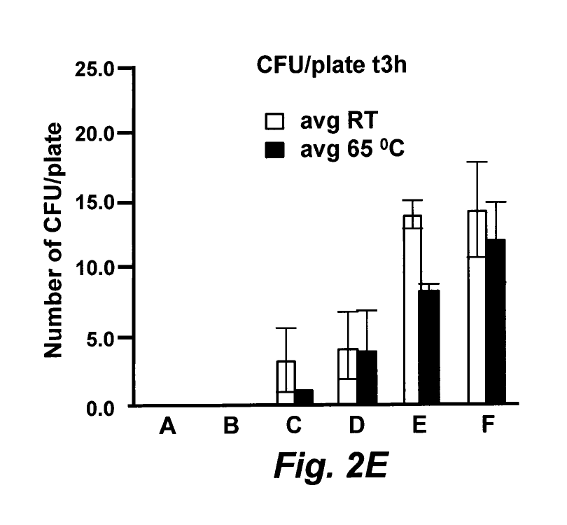

Experiment A3: 250 μl spore suspension (5×10⁴ spores) were added to 25 ml of the reagents. Sampling time points were t=0 (spores were added and after mixing with the reagent, 100 μl of the suspension were removed for enumeration), t=10 min, t=45 min, t=90 min, t=180 min. Average plate counts (FIGS. 1-13E) are based on counting three plates; error bars indicate +/−one standard deviation.
Experiments A4, A5: In experiment A4, 250 μl spore suspension (5×10⁴ spores) were added to 25 ml of the reagents. In experiment A5, 625 μl spore suspension (1.25×10⁵ spores) were added to 25 ml of the reagents. Sampling time points were t=0, t=1 h, t=2 h, t=3 h, t=4 h, t=5 h. To differentiate whether CFU originated from vegetative cells or from spores, at each time point samples were split in two equivalent aliquots. One aliquot was subjected to heat treatment (65° C., 30 min) to kill vegetative cells before enumeration of residual heat-resistant spores. The other aliquot was plated at room temperature (RT). Average plate counts (FIGS. 2A-2E and 3A-3E, respectively) are based on counting three plates; error bars indicate +/−one standard deviation.
Experiment A3: At t=45 min recovery of CFUs from flasks A and B was reduced to 9% (1.7 CFU) and 43% (8 CFU), respectively, as compared to control flask F. At t=90 min and t=180 min, zero colony forming units (CFU) were recovered from flasks A and B. For flasks C and D retrieval decreased over time but did not drop below 16% (reagent C) and 39% (reagent D) at 180 min. Recovery levels from the flask with reagent E did not decrease (Table 11).

TABLE 11
Experiment A3: CFU % recovery (as compared to control flask F)

| | 0 min | 10 min | 45 min | 90 min | 180 min |
|---|---|---|---|---|---|
| A | 85 | 81 | 9 | 0 | 0 |
| B | 121 | 66 | 43 | 0 | 0 |
| C | 142 | 77 | 82 | 48 | 16 |
| D | 108 | 81 | 55 | 64 | 39 |
| E | 119 | 65 | 94 | 144 | 95 |
| F | 100 | 100 | 100 | 100 | 100 |

Experiments A4, A5: In both experiments CFU recovery from flasks A and B at t=0 and t=1 h originated from heat-sensitive cells because colony counts were zero for the samples which received heat treatment. No CFU were retrieved from flask A or B for t=2 h, t=3 h, t=4 h (FIGS. 2A-2E and 3A-3E). For both reagents C and D % recovery decreased over time but of all compounds tested reagents A and B killed most effectively (Tables 17-20). Reagent E was not more effective than the water control F (FIGS. 2A-2E and 3A-3E).

TABLE 12
Experiment A4 absent heat: CFU % recovery
(as compared to control flask F): RT

| | 0 min | 1 h | 2 h | 3 h | 4 h |
|---|---|---|---|---|---|
| A | 81 | 2 | 0 | 0 | 0 |
| B | 85 | 12 | 0 | 0 | 0 |
| C | 81 | 71 | 33 | 23 | 15 |
| D | 89 | 54 | 27 | 30 | 15 |
| E | 85 | 90 | 87 | 98 | 79 |
| F | 100 | 100 | 100 | 100 | 100 |

TABLE 13
Experiment A4 with heat: CFU % recovery
(as compared to control flask F): 65° C.

| | 0 min | 1 h | 2 h | 3 h | 4 h |
|---|---|---|---|---|---|
| A | 0 | 0 | 0 | 0 | 0 |
| B | 0 | 0 | 0 | 0 | 0 |
| C | 27 | 13 | 6 | 8 | 0 |
| D | 70 | 78 | 45 | 33 | 46 |
| E | 48 | 53 | 74 | 68 | 114 |
| F | 100 | 100 | 100 | 100 | 100 |

TABLE 14
Experiment A5 absent heat: CFU % recovery
(as compared to control flask F): RT

| | 0 min | 1 h | 2 h | 3 h | 4 h |
|---|---|---|---|---|---|
| A | 128 | 6 | 0 | 0 | 0 |
| B | 124 | 6 | 0 | 0 | 0 |
| C | 97 | 58 | 44 | 32 | 16 |
| D | 105 | 80 | 46 | 67 | 37 |
| E | 122 | 117 | 103 | 113 | 103 |
| F | 100 | 100 | 100 | 100 | 100 |

TABLE 15
Experiment A5 with heat: CFU % recovery
(as compared to control flask F): 65° C.

| | 0 min | 1 h | 2 h | 3 h | 4 h |
|---|---|---|---|---|---|
| A | 0 | 0 | 0 | 0 | 0 |
| B | 0 | 0 | 0 | 0 | 0 |
| C | 58 | 32 | 18 | 8 | 8 |
| D | 75 | 58 | 34 | 34 | 14 |
| E | 71 | 69 | 53 | 71 | 54 |
| F | 100 | 100 | 100 | 100 | 100 |

While reagents C and D in a 4-hour time frame had a negative effect on spore survival, neither one of these reagents was as effective in killing spores as reagents A and B. Reagent E was not different from the water control F.

Viable cell counts demonstrated that reagents A and B affected heat sensitivity of spores very quickly at the t=0 time point suggesting induction of a break in spore dormancy. Chemical disinfectants which are not toxic and able to diminish resistance of spores to killing are potentially of great benefit.

### Example 6

Isolates: Bacillus subtilis strain ATCC #82 and B. cereus ATCC#10987 were obtained from ATCC, and B. circulans #47-10 and #31028 were from collection at Center for Food Safety. The frozen isolates were grown in brain heart infusion agar (BHA) at 37° C. for 24 h. Alicyclobacillus acidocaldarius strain OS-CAJ and SAC (isolated from apple juice concentrate), and N-1108 (isolated from apple-cranberry juice) were from collection at Center for Food Safety. The isolated were grown in Orange Serum Broth at 43° C. for 72 h and then transferred to potato dextrose agar (PDA) at 43° C. for 48 h.
Spore production: For B. cereus, B. subtilis, and B. circulans, the isolates were individually grown in 10-ml BHI for 24 hours and then, precipitated, suspended and washed for 3 times by centrifugation at 4,000×g for 20 min. The final pellet was transferred to 10-ml sporulation medium, containing FeCl₂, 0.0036 mM; MgCl₂, 0.041 mM; MnCl₂, 0.1 mM; NH₄Cl, 10 mM; Na₂SO₄, 0.75 mM; KH₂PO₄, 0.5 mM; CaCl₂, 1 mM; NH₄NO₃, 1.2 mM; D-glucose, 10 mM; and L-glutamic acid, 10 mM, pH 7.1 (Donnellan et al., (1964) J. Bact. 87: 332-335) at 30° C. for 5 days with agitation at 200 RPM. The spores were precipitated and suspended in 1-ml sterile H₂O by centrifugation at 4,000×g for 20 min. The solution was heated at 65° C. for 30 min and kept at 4° C. before use. For A. acidoterrestris isolates, the bacterium was individually grown in potato dextrose agar, pH 3.5 at 43° C. for 7 days and bacteria were collected by a plastic loop, suspended in 5-ml sterile H₂O containing 30 glass beads and vortexed for 2 min at 150 rpm. The solution was heated at 65° C. for 30 min and kept in 5° C. before use.
Spore staining: The Wirtz-Conklin spore stain was used for observation of spore morphology.
Chemicals: Levulinic acid and sodium dodecyl sulfate were obtained from Sigma-Aldrich (St. Louis, Mo.).
Water: Deionized, unchlorinated water was filter sterilized through a 0.2-μm regenerated cellulose filter (Corning Inc., Corning, N.Y.) was used for preparing chemical solution.
Inactivation of spores: Each 500-ml flasks containing 199-ml combined chemical solution with a magnetic bar at 200 rpm was individually heated to 62° C.±2° C. in a hot plate. A volume of 1.0-ml spore was added in the center of the chemical solution under constant mixing condition at 200 rpm.
Enumeration of spores: At pre-determined schedules a sample of 1.0-ml was removed from the flask and mixed with 9.0-ml 0.1 M phosphate buffer, pH 7.2 and then serial dilution (1:10) up to 10⁻⁸ CFU/ml was made and 0.1-ml from each diluted tubes was inoculated on the surface of either BHA plates for bacillus species or PDA plates for alicyclobacillus species. The plates were incubated at 37° C., 48 h for bacillus and at 43° C., 72 h for alicyclobacillus species. The species of colonies randomly picked from the highest dilution plates were confirmed by biochemical assays.

### Example 7

TABLE 16
B. subtilis (strain) ATCC #82 spores treated by
levulinic acid and SDS at 21° C.

| | 0.5% levulinic | 2% levulinic | 3% levulinic | H₂O |
|---|---|---|---|---|
| Time | acid + 0.05% SDS | acid + 1% SDS | acid + 2% SDS | only |
| (min) | Counts of spores (log CFU/ml) | | | |
| 0 | <0.7 | <0.7 | <0.7 | 5.5 ± 0.3 |
| 1 | <0.7 | <0.7 | <0.7 | 5.3 ± 0.1 |
| 2 | <0.7 | <0.7 | <0.7 | 5.4 ± 0.1 |
| 5 | <0.7 | <0.7 | <0.7 | 5.4 ± 0.1 |
| 10 | <0.7 | <0.7 | <0.7 | 5.3 ± 0.3 |
| 20 | <0.7 | <0.7 | <0.7 | 5.5 ± 0.1 |
| 30 | <0.7 | <0.7 | <0.7 | 5.3 ± 0.2 |
| 60 | <0.7 | <0.7 | <0.7 | 5.4 ± 0.1 |

^{a}, Inoculation of spore is 5.0 × 10⁷ CFU/ml after heating at 65° C. for 30 min.

### Example 8

TABLE 17
B. subtilis (strain ATCC #31028) spores treated
by levulinic acid and SDS at 21° C.

| | 3% levulinic | | 3% levulinic | |
|---|---|---|---|---|
| Time | acid + 2% SDS | H₂O only | acid + 2% SDS | H₂O only |
| (min) | Counts of spores (log CFU/ml) | | | |
| 1 | 6.2 ± 0.2 | 7.0 ± 0.1 | 5.8 ± 0.1 | 6.4 ± 0.2 |
| 3 | 6.2 ± 0.1 | ND | 5.9 ± 0.2 | ND |
| 5 | 6.1 ± 0.4 | ND | 5.8 ± 0.2 | ND |
| 10 | 6.1 ± 0.2 | ND | 5.7 ± 0.0 | ND |
| 20 | 6.1 ± 0.3 | ND | 5.8 ± 0.1 | ND |
| 30 | 5.9 ± 0.2 | ND | 5.7 ± 0.2 | ND |
| 60 | 6.2 ± 0.2 | ND | 5.8 ± 0.2 | ND |
| 90 | 6.2 ± 0.1 | ND | 5.8 ± 0.1 | ND |
| 120 | 6.3 ± 0.3 | 7.1 ± 0.3 | 5.8 ± 0.5 | 6.4 ± 0.3 |

^{a}, Inoculation of spore is 2.7 × 10⁸ CFU/ml after heating at 65° C. for 30 min.

### Example 9

TABLE 18
B. subtilis (strain ATCC #31028) spores treated by
levulinic acid and SDS at 21° C.

| Time | 10% levulinic acid + 2% SDS | H₂O only |
|---|---|---|
| (min) | Counts of spores (log CFU/ml) | |
| 5 | 6.2 ± 0.1 | 6.5 ± 0.3 |
| 10 | 5.9 ± 0.2 | ND |
| 30 | 6.0 ± 0.2 | ND |
| 60 | 6.2 ± 0.1 | ND |
| 120 | 6.1 ± 0.3 | ND |
| 180 | 6.2 ± 0.2 | ND |
| 240 | 6.1 ± 0.1 | 6.4 ± 0.2 |

### Example 10

TABLE 19
B. subtilis (strain ATCC #31028) spores treated by levulinic
acid and SDS at 21° C.

| Time | 20% levulinic acid + 3% SDS | H₂O only |
|---|---|---|
| (min) | Counts of spores (log CFU/ml) | |
| 5 | 6.0 ± 0.1 | 6.6 ± 0.3 |
| 15 | 6.1 ± 0.2 | ND |
| 30 | 5.9 ± 0.2 | ND |
| 60 | 6.0 ± 0.3 | ND |
| 90 | 5.8 ± 0.2 | ND |
| 120 | 5.6 ± 0.2 | 6.2 ± 0.5 |

### Example 11

TABLE 20
B. subtilis (strain ATCC #31028) spores treated by
levulinic acid and SDS at 62° C.

| Time | 3% levulinic acid + 2% SDS | H₂O only |
|---|---|---|
| (min) | Counts of spores (log CFU/ml) | |
| 1 | <0.7 | ND |
| 5 | <0.7 | ND |
| 15 | <0.7 | ND |
| 30 | <0.7 | ND |
| 60 | <0.7 | 5.0 ± 0.0 |

^{a}, Inoculums of B. subtilis ATCC #31028 is 1.6 × 10⁹/ml (germinated and spores).

### Example 12

TABLE 21
B. circulans (strain #47-10) spores treated by levulinic
acid and SDS at 21° C.

| Time | 0.5% levulinic acid + 0.05% SDS | H₂O only |
|---|---|---|
| (min) | Counts of spores (log CFU/ml) | |
| 0 | 2.2 ± 0.3 | 4.3 ± 0.4 |
| 1 | 2.4 ± 0.1 | ND |
| 2 | 1.9 ± 0.3 | ND |
| 5 | 2.1 ± 0.1 | 4.4 ± 0.1 |
| 10 | 2.1 ± 0.2 | ND |
| 20 | 1.6 ± 0.0 | ND |
| 30 | 1.0 ± 0.0 | 4.6 ± 0.1 |
| 60 | 1.3 ± 0.0 | 4.5 ± 0.2 |

^{a}, Inoculation of spore is 8.8 × 10⁶ CFU/ml after heating at 65° C. for 30 min.

### Example 13

TABLE 22
B. circulans (strain #47-10) spores treated by levulinic
acid and SDS at 21° C.

| Time | 3% levulinic acid + 2% SDS | H₂O only |
|---|---|---|
| (min) | Counts of spores (log CFU/ml) | |
| 1 | 5.2 ± 0.2 | 6.2 ± 0.2 |
| 3 | 5.5 ± 0.1 | ND |
| 5 | 5.0 ± 0.2 | ND |
| 10 | 5.1 ± 0.1 | ND |
| 20 | 5.2 ± 0.2 | ND |
| 30 | 5.2 ± 0.1 | ND |
| 60 | 4.9 ± 0.1 | ND |
| 90 | 4.6 ± 0.1 | ND |
| 120 | 4.4 ± 0.1 | ND |

^{a}, Inoculation of spore is 8.2 × 10⁸ CFU/ml after heating at 65° C. for 30 min.

### Example 14

TABLE 23
B. circulans (strain #47-10) spores treated by levulinic
acid and SDS at 21° C.

| Time | 3% levulinic acid + 2% SDS | H₂O only |
|---|---|---|
| (min) | Counts of spores (log CFU/ml) | |
| 1 | 4.5 ± 0.2 | 5.0 ± 0.2 |
| 3 | 4.5 ± 0.3 | ND |
| 5 | 4.6 ± 0.2 | ND |
| 10 | 4.6 ± 0.1 | ND |
| 20 | 4.5 ± 0.1 | ND |
| 30 | 4.6 ± 0.0 | ND |
| 60 | 4.5 ± 0.0 | ND |
| 90 | 4.4 ± 0.0 | ND |
| 120 | 4.0 ± 0.1 | 5.0 ± 0.2 |

^{a}, Inoculation of spore is 9.8 × 10⁶ CFU/ml after heating at 65° C. for 30 min.

### Example 15

TABLE 24
B. circulans (strain #47-10) spores treated by levulinic
acid and SDS at 21° C.

| Time | 10% levulinic acid + 2% SDS | H₂O only |
|---|---|---|
| (min) | Counts of spores (log CFU/ml) | |
| 5 | 5.0 ± 0.1 | 5.0 ± 0.2 |
| 10 | 4.9 ± 0.1 | ND |
| 30 | 4.3 ± 0.2 | ND |
| 60 | 3.5 ± 0.0 | ND |
| 120 | 2.8 ± 0.1 | ND |
| 180 | <0.7 | ND |
| 240 | <0.7 | 5.0 ± 0.2 |

^{a}, Inoculation of spore is 9.3 × 10⁶ CFU/ml after heating at 65° C. for 30 min.

### Example 16

TABLE 25
B. cereus (strain ATCC #10987) spores treated by
levulinic acid and SDS at 21° C.

| Time | 0.5% levulinic acid + 0.05% SDS | H₂O only |
|---|---|---|
| (min) | Counts of spores (log CFU/ml) | |
| 0 | 4.8 ± 0.1 | 4.8 ± 0.1 |
| 1 | 4.8 ± 0.3 | ND |
| 2 | 4.7 ± 0.1 | ND |
| 5 | 4.4 ± 0.3 | 4.8 ± 0.2 |
| 10 | 4.2 ± 0.4 | ND |
| 20 | 3.8 ± 0.2 | ND |
| 30 | 3.8 ± 0.1 | 4.9 ± 0.1 |
| 60 | 3.7 ± 0.1 | 4.8 ± 0.2 |

^{a}, Inoculation of spore is 2.2 × 10⁷ CFU/ml after heating at 65° C. for 30 min.

### Example 17

TABLE 26
B. cereus (strain ATCC #10987) spores treated by
levulinic acid and SDS at 21° C.

| Time | 3% levulinic acid + 2% SDS | H₂O only |
|---|---|---|
| (min) | Counts of spores (log CFU/ml) | |
| 1 | 6.5 ± 0.1 | 6.7 ± 0.1 |
| 3 | 6.5 ± 0.2 | ND |
| 5 | 6.7 ± 0.1 | ND |
| 10 | 6.5 ± 0.1 | ND |
| 20 | 6.4 ± 0.1 | ND |
| 30 | 6.7 ± 0.2 | ND |
| 60 | 6.7 ± 0.1 | ND |
| 90 | 6.7 ± 0.1 | ND |
| 120 | 6.7 ± 0.1 | 7.1 ± 0.2 |

^{a}, Inoculation of spore is 4.0 × 10⁸ CFU/ml after heating at 65° C. for 30 min.

### Example 18

TABLE 27
B. cereus (strain ATCC #10987) spores treated by
levulinic acid and SDS at 21° C.

| | 10% levulinic | H₂O | 20% levulinic | H₂O |
|---|---|---|---|---|
| Time | acid + 2% SDS | only | acid + 3% SDS | only |
| (min) | Counts of spores (log CFU/ml) | | | |
| 5 | 6.2 ± 0.4 | 6.6 ± 0.1 | 6.3 ± 0.3 | 6.7 ± 0.2 |
| 10 | 6.6 ± 0.1 | ND | ND | ND |
| 15 | ND | ND | 6.3 ± 0.2 | ND |
| 30 | 6.1 ± 0.2 | ND | 6.3 ± 0.1 | ND |
| 60 | 6.3 ± 0.3 | ND | 6.3 ± 0.2 | ND |
| 90 | ND | ND | 6.2 ± 0.2 | ND |
| 120 | 6.3 ± 0.0 | ND | 6.0 ± 0.1 | 6.5 ± 0.3 |
| 180 | 6.2 ± 0.1 | ND | 5.8 ± 0.1 | ND |
| 240 | 6.6 ± 0.0 | 6.7 ± 0.2 | ND | ND |

^{a}, Inoculation of spore is 6.1 × 10⁸ CFU/ml after heating at 65° C. for 30 min.

### Example 19

TABLE 28
B. cereus spores treated by levulinic acid and SDS at 62° C. + 2° C.

| | | 3% levulinic acid + | |
|---|---|---|---|
| | Time | 2% SDS at 62° C. | H₂O at 62° C. |
| Strain | (min) | Counts of spores (log CFU/ml) | |
| B. cereus | 0 | <0.7 | 6.1 ± 0.1 |
| (ATCC#10987) | 1 | <0.7 | ND |
| | 5 | <0.7 | ND |
| | 20 | <0.7 | ND |
| | 30 | <0.7 | ND |
| | 60 | <0.7 | 5.7 ± 0.1 |
| B. circulans | 0 | <0.7 | 4.5 ± 0.3 |
| (#47-10) | 1 | <0.7 | ND |
| | 2 | <0.7 | ND |
| | 5 | <0.7 | ND |
| | 10 | <0.7 | ND |
| | 20 | <0.7 | 3.7 ± 0.1 |

### Example 20

TABLE 29
Alicyclobacillus acidoterrestris (bacteria + spores) treated by levulinic acid
and SDS at 62° C. ± 2° C.

| | | 3% levulinic acid + | |
|---|---|---|---|
| | Time | 2% SDS at 62° C. | H₂O at 62° C. |
| Strain | (min) | Counts of spores (log CFU/ml) | |
| #SAC, #OS-CAS, | 0 | <0.7 | 6.5 ± 0.1 |
| and #N-1108 | 10 | <0.7 | 6.1 ± 0.1 |
| | 30 | <0.7 | 4.6 ± 0.2 |
| | 60 | <0.7 | 3.8 ± 0.1 |

^{a}, Inoculation of a mixture of 3-strains A. acidoterrestris, including strains #SAC, #OS-CAS, and #N-1108 is 1.1 × 10⁹/ml.

### Example 21

TABLE 30
Alicyclobacillus acidoterrestris (bacteria + spores) treated by levulinic acid and SDS
at 21° C. and 62° C.

| | | 3% levulinic acid + | | 3% levulinic acid + | |
|---|---|---|---|---|---|
| | Time | 2% SDS at 21° C. | H₂O at 21° C. | 2% SDS at 62° C. | H₂O at 62° C. |
| Strain | (min) | Counts of spores (log CFU/ml) | | | |
| SAC | 0 | 4.7 ± 0.2 | 4.8 ± 0.1 | ND | ND |
| | 1 | ND | ND | <0.7 | 5.0 ± 0.2 |
| | 5 | ND | ND | <0.7 | 5.1 ± 0.2 |
| | 10 | ND | ND | <0.7 | 5.1 ± 0.1 |
| | 30 | 4.6 ± 0.2 | ND | ND | ND |
| | 60 | 4.7 ± 0.2 | 4.8 ± 0.1 | ND | ND |
| OS-CAS | 0 | 4.5 ± 0.1 | 4.9 ± 0.1 | ND | ND |
| | 1 | ND | ND | <0.7 | 5.0 ± 0.1 |
| | 5 | ND | ND | <0.7 | 5.0 ± 0.3 |
| | 10 | ND | ND | <0.7 | 5.2 ± 0.2 |
| | 30 | 4.4 ± 0.1 | ND | ND | ND |
| | 60 | 4.1 ± 0.2 | 4.9 ± 0.1 | ND | ND |
| N-1108 | 0 | 4.8 ± 0.1 | 5.1 ± 0.2 | ND | ND |
| | 1 | ND | ND | <0.7 | 5.0 ± 0.1 |
| | 5 | ND | ND | <0.7 | 5.1 ± 0.1 |
| | 10 | ND | ND | <0.7 | 5.1 ± 0.0 |
| | 30 | 4.8 ± 0.1 | ND | ND | ND |
| | 60 | 3.9 ± 0.2 | 5.1 ± 0.1 | ND | ND |

^{a}, Inoculation of mixture for isolate SAC is 1.6 × 10⁸ CFU/ml, for OS-CAS is 2.6 × 10⁷ CFU/ml, and for N-1108 is 6.3 × 10⁷ CFU/ml.

### Example 22

TABLE 31
Counts of Alicyclobacillus acidoterrestris spores
(pre-treated for 30 min at 65° C.)

| | | Counts of A. acidoterrestris (log CFU/ml) | |
|---|---|---|---|
| Bacterial | Time | 3% levulinic acid + | |
| isolates | (Sec) | 2% SDS at 62° C. | H₂O at 62° C. |
| SAC | 0 | 4.3 | |
| | 15 | 4.3 | |
| | 30 | 3.4 | |
| | 60 | 3.3 | |
| | 90 | 2.7 | |
| | 300 | | 5.2 |
| OS-CAS | 0 | 4.3 | |
| | 15 | 4.3 | |
| | 30 | 4.4 | |
| | 60 | 4.0 | |
| | 90 | 3.4 | |
| | 300 | | 5.4 |
| N-1108 | 0 | 4.2 | |
| | 15 | 4.5 | |
| | 30 | 4.4 | |
| | 60 | 4.2 | |
| | 90 | 3.7 | |
| | 300 | | 5.3 |

^{a}, Inoculation of spore (after treated at 65° C. for 30 min) for isolate SAC is 8.0 × 10⁷ CFU/ml, for OS-CAS is 7.2 × 10⁷ CFU/ml, and for N-1108 is 6.3 × 10⁷ CFU/ml.

TABLE 32
Effect of levulinic acids plus SDS at 21° C. on various yeast species

| | Yeast counts (log CFU/ml) at min: | | | | | | | |
|---|---|---|---|---|---|---|---|---|
| Yeast Name^{a} | 0^{b} | 1 | 2 | 5 | 10 | 20 | 30 | 60 |
| Saccharomyces cerevisiae in 0.1M PBS | 5.2 | 5.3 | 5.5 | 5.3 | 5.3 | 5.2 | 5.3 | 5.3 |
| (Control) | | | | | | | | |
| Saccharomyces cerevisiae in 2.0% | 5.4 | 5.3 | 5.5 | 5.4 | 5.3 | 5.3 | 5.5 | 5.0 |
| levulinic acid (Control) | | | | | | | | |
| S. cerevisiae in 1.0% SDS (Control) | 2.7 | 2.4 | 2.6 | 2.3 | 2.8 | 2.7 | 2.3 | 2.4 |
| S. cerevisiae in 0.5% levulinic + 0.05% | 4.9 | 4.5 | 3.9 | 3.2 | 2.7 | 1.7 | 1.3 | <0.7 |
| SDS | | | | | | | | |
| S. cerevisiae in 2% levulinic acid + 1.0% | 0.7 | — | — | — | — | — | — | — |
| SDS | | | | | | | | |
| Debaryomyces hansenii in 0.1M PBS | 4.8 | 4.9 | 4.9 | 4.8 | 4.8 | 4.8 | 4.8 | 4.8 |
| (Control) | | | | | | | | |
| D. hansenii in 2.0% levulinic acid (Control) | 4.9 | 4.8 | 4.9 | 4.6 | 4.4 | 4.7 | 3.0 | 1.3 |
| D. hansenii in 1.0% SDS (Control) | 4.5 | 4.5 | 4.1 | 4.5 | 4.4 | 4.5 | 4.5 | 4.4 |
| D. hansenii in 0.5% levulinic acid + 0.05% | 4.9 | 4.9 | 4.7 | 4.5 | 4.3 | 3.7 | 3.1 | 1.7 |
| SDS | | | | | | | | |
| D. hansenii 2% levulinic acid + 1% SDS | 1.0 | — | — | — | — | — | — | — |
| Candida magnoliae in 0.1M PBS (Control) | 5.9 | 5.8 | 6.1 | 5.9 | 5.9 | 5.9 | 5.9 | 5.7 |
| C. magnoliae in 2.0% levulinic acids | 6.0 | 5.9 | 5.9 | 5.9 | 6.0 | 6.0 | 5.9 | 5.8 |
| (Control) | | | | | | | | |
| C. magnoliae in 1.0% SDS (Control) | 3.5 | 3.5 | 3.3 | 3.2 | 3.2 | 2.7 | 3.0 | 3.1 |
| C. magnoliae in 0.5% levulinic acids + | 4.0 | 3.6 | 3.2 | 2.1 | 1.3 | <0.7 | <0.7 | <0.7 |
| 0.05% SDS | | | | | | | | |
| C. magnoliae in 2.0% levulinic acid + 1.0% | 2.1 | 0.7 | — | — | — | — | — | — |
| SDS | | | | | | | | |
| Zygosaccharomyces bailii in 0.1M PBS | 5.4 | 5.5 | 5.6 | 5.5 | 5.3 | 5.4 | 5.6 | 5.5 |
| (Control) | | | | | | | | |
| Z. bailii in 2% levulinic acid (Control) | 5.4 | 5.4 | 5.5 | 5.4 | 5.4 | 5.4 | 5.4 | 5.3 |
| Z. bailii in 1.0% SDS (Control) | 4.6 | 4.7 | 4.6 | 4.6 | 4.6 | 4.5 | 4.5 | 4.4 |
| Z. bailii in 0.5% levulinic acid + 0.05% SDS | 5.0 | 5.0 | 4.8 | 3.6 | 3.8 | 2.3 | 2.6 | <0.7 |
| Z. bailii in 2% levulinic acid + 1% SDS | 4.6 | 4.2 | 3.9 | 2.9 | 2.0 | <0.7 | <0.7 | <0.7 |
| Geotrichum candidum 0.1M PBS (Control) | 4.6 | 4.7 | 4.8 | 4.7 | 4.7 | 4.5 | 4.6 | 4.6 |
| G. candidum in 2.0% levulinic acid | 4.6 | 4.4 | 4.4 | 4.3 | 4.1 | 3.8 | 3.4 | 2.0 |
| (Control) | | | | | | | | |
| G. candidum in 1.0% SDS (Control) | 3.6 | 3.8 | 3.3 | 3.5 | 3.7 | 3.5 | 3.4 | 3.3 |
| G. candidum in 0.5% levulinic acid + | 3.0 | 2.6 | 2.6 | 2.4 | <0.7 | <0.7 | <0.7 | <0.7 |
| 0.05% SDS | | | | | | | | |
| G. candidum in 2.0% levulinic acid + 1.0% | 3.3 | <0.7 | — | — | — | — | — | — |
| SDS | | | | | | | | |

^{a}Initial inoculation level: Saccharomyces cerevisiae: 7.5 × 10⁷ CFU/ml; Debaryomyces hansenii: 7.4 × 10⁷ CFU/ml; Candida magnoliae: 3.4 × 10⁸ CFU/ml; Zygosaccharomyces bailii: 3.4 × 10⁷ CFU/ml; Geotrichum candidum: 1.2 × 10⁷ CFU/ml.
^{b}The actual time 0 was delayed by 5 to 10 seconds due to time for sample processing.
^{c}Negative by direct plating and enrichment culture.

TABLE 33
Effect of levulinic acids plus SDS at 21° C. on various mold species

| | Mold counts (log CFU/ml) at min: | | | | | | | |
|---|---|---|---|---|---|---|---|---|
| Mold Name^{a} | 0^{b} | 1 | 2 | 5 | 10 | 20 | 30 | 60 |
| Mucor hiemalis in 0.1M PBS (Control) | 6.1 | 6.1 | 6.1 | 6.2 | 6.4 | 6.1 | 6.1 | 6.2 |
| M. hiemalis in 3.0% levulinic acids | 6.1 | 6.2 | 6.2 | 6.0 | 5.8 | 5.1 | 4.8 | 4.1 |
| (Control) | | | | | | | | |
| M. hiemalis in 2.0% SDS (Control) | 6.0 | 5.8 | 5.8 | 6.0 | 5.9 | 5.8 | 5.8 | 5.4 |
| M. hiemalis in 0.5% levulinic + 0.05% SDS | 5.8 | 5.9 | 6.0 | 6.1 | 5.5 | 5.8 | 5.9 | 5.4 |
| M. hiemalis in 2% levulinic acid + 1.0% | 5.1 | 5.0 | 4.9 | 4.9 | 4.5 | 3.7 | 3.4 | 2.5 |
| SDS | | | | | | | | |
| M. hiemalis in 3% levulinic acid + 2% SDS | 5.6 | 5.6 | 5.5 | 5.0 | 4.7 | 4.6 | 3.2 | 2.4 |
| Penicillium pubeseus in 0.1M PBS | 4.9 | 4.8 | 4.8 | 4.8 | 4.9 | 4.8 | 4.9 | 4.7 |
| (Control) | | | | | | | | |
| P. pubeseus in 3.0% levulinic acid | 5.2 | 4.9 | 4.8 | 5.2 | 4.0 | 3.2 | 2.7 | 1.7 |
| P. pubeseus in 2.0% SDS | 4.4 | 4.3 | 4.4 | 4.4 | 4.5 | 4.5 | 4.4 | 4.4 |
| P. pubeseus in 0.5% levulinic acid + | 5.1 | 5.1 | 5.1 | 5.0 | 5.0 | 4.9 | 4.9 | 4.5 |
| 0.05% SDS | | | | | | | | |
| P. pubeseus 2% levulinic acid + 1% SDS | 5.2 | 5.2 | 5.1 | 5.0 | 4.8 | 4.6 | 4.4 | 4.2 |
| P. pubeseus in 3% levulinic acid + 2% | 3.5 | 3.2 | <0.7 | <0.7 | <0.7 | <0.7 | <0.7 | <0.7 |
| SDS | | | | | | | | |
| Penicillium. expansum in 0.1M PBS | 4.4 | 4.4 | 4.5 | 4.8 | 4.6 | 4.0 | 4.5 | 4.5 |
| (Control) | | | | | | | | |
| P. expansum in 3.0% levulinic acids | 4.3 | 4.4 | 4.2 | 4.0 | 3.7 | 3.3 | 3.3 | 2.4 |
| P. expansum in 2.0% SDS | 4.2 | 4.1 | 3.8 | 3.4 | 3.5 | 3.5 | 3.5 | 3.6 |
| P. expansum in 0.5% levulinic acid + | 4.5 | 3.9 | 3.6 | 3.2 | 2.8 | 2.7 | 2.0 | 2.0 |
| 0.05% SDS | | | | | | | | |
| P. expansum in 2.0% levulinic acids + | 4.1 | 3.7 | 3.6 | 3.4 | 3.3 | 3.0 | 2.5 | 1.7 |
| 1.0% SDS | | | | | | | | |
| Paecylomyces expansum in 3% levulinic | 3.9 | <0.7 | <0.7 | <0.7 | <0.7 | <0.7 | <0.7 | <0.7 |
| acid + 2% SDS | | | | | | | | |
| P. variotri in 0.1M PBS (Control) | 5.5 | 5.5 | 5.7 | 5.4 | 5.5 | 5.5 | 5.5 | 5.5 |
| P. variotri in 3.0% levulinic acid | 5.6 | 5.6 | 5.4 | 5.6 | 5.6 | 5.3 | 5.4 | 4.6 |
| P. variotri in 2.0% SDS | 5.6 | 5.5 | 5.5 | 5.4 | 5.4 | 5.6 | 5.6 | 5.6 |
| P. variotri in 0.5% levulinic acid + 0.05% | 5.2 | 5.2 | 4.8 | 4.5 | 4.1 | 4.4 | 3.8 | 3.4 |
| SDS | | | | | | | | |
| P. variotri in 2.0% levulinic acid + 1.0% | 4.3 | 3.8 | 3.4 | 3.0 | 2.7 | 2.3 | 1.5 | 0.7 |
| SDS | | | | | | | | |
| P. variotri in 3.0% levulinic acid + 2.0% | 4.6 | 4.4 | 4.4 | 3.6 | 2.9 | 2.2 | <0.7 | <0.7 |
| SDS | | | | | | | | |

^{a}Initial inoculation level: Mucor hiemalis: 3.1 × 10⁷ CFU/ml; Penicillium pubeseus: 6.9 × 10⁷ CFU/ml; Penicillium expansum: 2.9 × 10⁷ CFU/ml; Paecylomyces variotri: 2.7 × 10⁷ CFU/ml.
^{b}The actual time 0 was delayed by 5 to 10 seconds due to time for sample processing.

TABLE 34
Inactivation of Alicyclobacillus acidoterrestris spores by 3% levulinic acid plus 2%
SDS at 70° C. or 80° C.

| | | A. acidoterrestris counts (log CFU/ml) | | | |
|---|---|---|---|---|---|
| | Time | 3% levulinic acid + | H₂O at | 3% levulinic acid + | H₂O at |
| Strain | (min) | 2% SDS at 70° C. | 70° C. | 2% SDS at 80° C. | 80° C. |
| SAC | 0 | 5.0 | ND | 2.2 | ND |
| | 1 | 3.0 | ND | 0.7 | ND |
| | 2 | <0.7 | ND | <0.7 | ND |
| | 3 | <0.7 | ND | <0.7 | ND |
| | 5 | <0.7 | ND | <0.7 | ND |
| | 10 | <0.7 | 6.0 | <0.7 | 6.0 |
| | 20 | <0.7 | 6.1 | <0.7 | 6.1 |
| OS-CAS | 0 | 5.3 | ND | <0.7 | ND |
| | 1 | 3.0 | ND | <0.7 | ND |
| | 2 | <0.7 | ND | <0.7 | ND |
| | 3 | <0.7 | ND | <0.7 | ND |
| | 5 | <0.7 | ND | <0.7 | ND |
| | 10 | <0.7 | 6.0 | <0.7 | 6.0 |
| | 20 | <0.7 | 6.1 | <0.7 | 5.9 |
| N-1108 | 0 | 4.6 | ND | 3.6 | 5.6 |
| | 1 | 3.7 | ND | <0.7 | ND |
| | 2 | <0.7 | ND | <0.7 | ND |
| | 3 | <0.7 | ND | <0.7 | ND |
| | 5 | <0.7 | ND | <0.7 | ND |
| | 10 | <0.7 | 6.2 | <0.7 | 5.7 |
| | 20 | <0.7 | 6.2 | <0.7 | 5.8 |

^{a}, Spore inoculum (after treatment of 65° C. for 30 min) for strain SAC was 9.4 × 10⁷ CFU/ml, for OS-CAS was 1.1 × 10⁸ CFU/ml, and for N-1108 was 1.6 × 10⁸ CFU/ml.

### Example 23

The average S. typhimurium count of apples treated with water only for 1, 2, and 5 min was 2.65, 2.7, and 2.65 log CFU/apple, respectively. The average S. typhimurium count of apples treated with 0.5% levulinic acid plus 0.05% SDS was <0.7, 1.35, and <0.7 log CFU/apple, respectively. The reduction of S. typhimurium on the surface of apples treated with 0.5% levulinic acid plus 0.05% SDS for 1, 2, and 5 min was 2.0, 1.4, and 2.0 log CFU/apple (Table 35). Similar results were obtained for aerobic plate counts (APC). Substantial reduction of yeasts and molds (>1.0 log CFU/apple) on apples required 5 min of exposure.

Following treatment, the microbial counts of the treatment solution containing 0.5% levulinic acid plus 0.05% SDS) were <0.7 log S. typhimurium/ml, and 1.7 log Y&M/ml; containing 50 ppm acidified sodium chlorite were <0.7 log S. typhimurium/ml, and 1.6 log Y&M/ml; with water only were 2.7 log S. typhimurium/ml, and 1.6 log Y&M/ml. The S. typhimurium counts on apples treated for 1, 2, and 5 min with 50 ppm acidified sodium chlorite was 3.25, 3.1, and 2.8 log CFU/apple, respectively, with no reduction of Salmonella counts (Table 35).

TABLE 35
Microbial counts on apples treated at 21° C. for different times in a 4-L tank.

| | | Treated with 0.5% | | | Treated with 50 ppm | | | | | |
|---|---|---|---|---|---|---|---|---|---|---|
| | | levulinic acid plus | | | acidified sodium | | | | | |
| Apple | | 0.05% SDS, pH 3.1 | | | chlorite, pH 4.6 | | | Treated with water only | | |
| group | Time | Microbial counts (log CFU/whole apple) | | | | | | | | |
| No. | (min) | Salmonella | APC | Y&M | Salmonella | APC | Y&M | Salmonella | APC | Y&M |
| 1 | 1 | 0.7 | <1.7 | 3.1 | 3.3 | 3.7 | 3.2 | 2.7 | 3.6 | 3.4 |
| | 2 | 1.3 | 2.7 | 3.9 | 3.4 | 3.7 | 3.5 | 2.7 | 3.6 | 2.8 |
| | 5 | <0.7 | <1.7 | 2.3 | 3.2 | 4.9 | 3.9 | 3.0 | 5.0 | 4.0 |
| 2 | 1 | <0.7 | 2.7 | 3.2 | 3.2 | 3.4 | 3.2 | 2.5 | 3.1 | 2.8 |
| | 2 | 1.3 | 1.4 | 1.0 | 2.6 | 2.7 | 3.6 | 2.8 | 3.0 | 2.8 |
| | 5 | 1.2 | <1.7 | 1.3 | 2.9 | 3.2 | 3.7 | 2.8 | 3.0 | 3.0 |
| 3 | 1 | <0.7 | <1.7 | 3.5 | 3.3 | 3.6 | 2.9 | 2.7 | 2.3 | 3.0 |
| | 2 | 1.5 | 2.5 | 3.9 | 3.3 | 3.4 | 3.9 | 2.7 | 3.1 | 2.9 |
| | 5 | <0.7 | <1.7 | 2.4 | 2.4 | 3.9 | 3.2 | 2.5 | 2.9 | 2.9 |
| 4 | 1 | <0.7 | <1.7 | 3.1 | 3.2 | 3.6 | 3.0 | 2.7 | 2.8 | 3.0 |
| | 2 | 1.3 | <1.7 | 3.4 | 3.1 | 4.5 | 3.5 | 2.6 | 2.9 | 3.0 |
| | 5 | <0.7 | 2.3 | 2.1 | 2.7 | 2.9 | 3.3 | 2.3 | 3.4 | 3.2 |

Inoculum level for S. typhimurium was 1.1×10⁶ CFU/ml; initial yeast and mold (Y&M) count was 4.0×10⁴ CFU/ml.

Background aerobic plant count before inoculation of apple 1 was 4.0 log CFU/apple; of apple 2 was 3.6 log CFU/apple.

Following inoculation, S. typhimurium count of apple 1 was 4.0 log S. typhimurium/apple; apple 2 was 4.8 log S. typhimurium/apple.

### Example 24

The average S. typhimurium count on celery treated with water only for 1, 2, and 5 min was 3.65, 3.57, and 3.5 log CFU/celery, respectively; and on celery treated with 0.5% levulinic acid plus 0.05% SDS was 1.1, 1.0, and 1.3 log CFU/celery, respectively, representing a 2.2-2.6 log CFU S. typhimurium CFU/celery reduction (Table 36). S. typhimurium counts on celery treated with 50 ppm of acidified sodium chlorite for 1, 2, and 5 min were 3.4, 3.1, and 3.0 log CFU, respectively; with a reduction of about 0.5 log S. typhimurium/celery (Table 36). Following treatment, the microbial counts in the treatment solutions were <log 0.7 log S. typhimurium/ml, and 1.3 log Y&M/ml in the 0.5% levulinic acid plus 0.05% SDS-treatment solution; and were <0.7 log S. typhimurium and 2.3 log Y&M/ml in the 50 ppm acidified sodium chlorite solution; and were 3.2 log S. typhimurium/ml, and 3.5 log Y&M/ml in the water-treatment solution.

TABLE 36
Microbial counts on celery treated with different chemicals at 21° C. for different times in a 4-L tank.

| | | Treated with 0.5% | | | Treated with 50 ppm | | | | | |
|---|---|---|---|---|---|---|---|---|---|---|
| | | levulinic acid plus | | | acidified sodium chlorite, | | | Treated with water | | |
| Celery | | 0.05% SDS, pH 3.1 | | | pH 4.6 | | | only | | |
| group | Time | Microbial counts (log CFU/celery) | | | | | | | | |
| No. | (min) | Salmonella | APC | Y&M | Salmonella | APC | Y&M | Salmonella | APC | Y&M |
| 1 | 1 | 2.0 | 4.5 | 3.4 | 3.6 | 6.4 | 5.5 | 3.8 | 6.0 | 5.5 |
| | 2 | 0.7 | 4.9 | 2.3 | 3.1 | 5.9 | 5.1 | 3.8 | 6.3 | 5.5 |
| | 5 | 1.5 | 3.3 | 3.4 | 2.8 | 4.5 | 4.9 | 3.7 | 6.0 | 4.9 |
| 2 | 1 | 0.7 | 3.1 | 4.1 | 3.3 | 5.4 | 5.2 | 4.0 | 5.8 | 4.4 |
| | 2 | 1.4 | 2.8 | 4.1 | 3.1 | 4.6 | 5.0 | 3.6 | 6.2 | 5.5 |
| | 5 | 1.4 | 2.8 | 4.1 | 2.8 | 5.4 | 5.0 | 3.3 | 5.1 | 5.2 |
| 3 | 1 | 1.0 | 2.7 | 3.9 | 3.3 | 6.1 | 5.5 | 3.1 | 5.3 | 5.4 |
| | 2 | 0.7 | 3.0 | 3.9 | 3.1 | 5.9 | 5.4 | 3.2 | 4.8 | 5.1 |
| | 5 | 1.4 | 5.3 | 4.6 | 2.9 | 3.7 | 5.1 | 3.4 | 5.9 | 5.3 |
| 4 | 1 | 0.7 | 3.5 | 4.5 | 3.4 | 6.0 | 5.5 | 3.7 | 5.6 | 4.9 |
| | 2 | 1.2 | 4.7 | 3.4 | 3.2 | 5.2 | 5.2 | 3.7 | 5.1 | 4.8 |
| | 5 | 1.0 | 3.6 | 3.4 | 3.6 | 6.2 | 5.4 | 3.6 | 5.1 | 5.2 |

Inoculum level for S. typhimurium was 1.2×10⁶ CFU/ml; initial yeast and mold (Y&M) count was 1.0×10⁵ CFU/ml.

Background aerobic plate count before inoculation of celery 1 was 7.0 log CFU/celery; of celery 2 was 7.0 log CFU/celery. Following inoculation, S. typhimurium count of celery 1 was 5.2 log S. typhimurium/celery; celery 2 was 4.8 log S. typhimurium/celery.

### Example 25

The average S. typhimurium counts on onions treated with water only for 1, 2, and 5 min at 21° C. were 4.2, 4.0, and 4.0 log CFU per onion, respectively; whereas the average S. Typhimurium counts on onions treated with 0.5% levulinic acid plus 0.05% SDS for 1, 2, and 5 min were 2.07, 2.05, and 1.65 CFU per onion, respectively, representing an average reduction of 2.13, 1.95, and 2.3 log S. typhimurium CFU per onion, respectively (Table 37). Treatment with 50 ppm acidified sodium chlorite resulted in a small reduction (<0.5 log CFU per onion) of S. typhimurium, APC, and yeast and mold counts (Table 37).

Following treatment, the microbial counts of the treatment solutions revealed the counts were <log 0.7 log S. typhimurium/ml and 2.7 log Y&M/ml in the 0.5% levulinic acid plus 0.05% SDS-treatment solution; were <0.7 log S. typhimurium, and 2.6 log Y&M/ml in the 50 ppm acidified sodium chlorite treatment solution; and were 3.2 log S. typhimurium/ml and 3.1 log Y&M/ml in the water-treatment solution.

TABLE 37
Microbial counts on onions treated at 21° C. for different times in a 4-L tank.

| | | Treated with 0.5% levulinic | | | Treated with 50 ppm | | | | | |
|---|---|---|---|---|---|---|---|---|---|---|
| | | acid plus 0.05% SDS, pH | | | acidified sodium chlorite, | | | | | |
| Onion | | 3.1 | | | pH 4.6 | | | Treated with water only | | |
| group | Time | Microbial counts (log CFU/whole onion) | | | | | | | | |
| No. | (min) | Salmonella | APC | Y&M | Salmonella | APC | Y&M | Salmonella | APC | Y&M |
| 1 | 1 | 2.4 | 4.9 | 3.1 | 4.1 | 5.2 | 4.6 | 4.2 | 5.5 | 3.9 |
| | 2 | 2.2 | 3.6 | 4.7 | 4.0 | 6.0 | 4.7 | 4.2 | 5.5 | 4.7 |
| | 5 | 1.7 | 4.4 | 2.9 | 3.5 | 6.4 | 4.5 | 3.8 | 6.4 | 5.4 |
| 2 | 1 | 2.0 | 4.4 | 2.9 | 4.0 | 4.4 | 3.8 | 4.2 | 6.3 | 4.8 |
| | 2 | 1.9 | 4.1 | 4.9 | 3.9 | 6.3 | 3.8 | 4.0 | 5.2 | 3.7 |
| | 5 | 1.8 | 3.8 | 4.7 | 4.0 | 6.4 | 4.3 | 3.9 | 5.7 | 4.3 |
| 3 | 1 | 1.9 | 5.2 | 4.0 | 3.8 | 5.3 | 3.8 | 4.1 | 6.1 | 4.2 |
| | 2 | 2.1 | 3.1 | 4.1 | 3.8 | 6.7 | 3.4 | 3.7 | 4.7 | 4.5 |
| | 5 | 2.0 | 3.4 | 3.9 | 3.6 | 5.9 | 3.3 | 3.8 | 5.9 | 3.6 |
| 4 | 1 | 2.0 | 4.5 | 3.4 | 4.0 | 5.3 | 4.6 | 4.3 | 6.4 | 4.6 |
| | 2 | 1.0 | 3.9 | 4.2 | 3.9 | 5.4 | 4.6 | 4.2 | 5.7 | 3.3 |
| | 5 | 1.1 | 3.9 | 5.4 | 3.6 | 5.2 | 4.0 | 4.3 | 6.2 | 4.1 |

Inoculum level for S. typhimurium was 1.0×10⁶ CFU/ml.

Background aerobic plate count before inoculation of onion 1 was 6.4 log CFU per onion; of onion 2 was 5.2 log CFU per onion.

Following inoculation, S. typhimurium count of onion 1 was 5.1 log S. typhimurium per onion; onion 2 was 5.2 log S. typhimurium per onion.

### Example 26

Most cantaloupes contain dirt at different degrees thereby increasing the challenge for killing microbes by chemical wash treatments. The average S. typhimurium count, aerobic plate count, and yeast and mold count on cantaloupes treated by water only for 5 min at 21° C. were 3.76, 5.07, and 4.94 log CFU/cantaloupe, respectively. The average S. typhimurium count, aerobic plate count, and yeast and mold on cantaloupes treated with 1.0% levulinic acid plus 0.1% SDS for 5 min were 1.5, 4.2, and 4.46 log CFU/cantaloupe, respectively (Table 32), hence, the average reduction of S. typhimurium, APC, and yeast and mold counts were 2.26, 0.87, and 0.48 log CFU/cantaloupe, respectively. The S. typhimurium counts on cantaloupes treated with 50 ppm acidified sodium chlorite were reduced by only 0.46 log CFU per cantaloupe (Table 38).

Following treatment, the microbial counts in the treatment solutions were <0.7 log S. typhimurium/ml, and 1.7 log Y&M/ml for the 1.0% levulinic acid plus 0.1% SDS, <0.7 log S. typhimurium, and 3.9 log Y&M/ml for 50 ppm acidified sodium chlorite, and 3.9 log S. typhimurium/ml, and 1.8 log Y&M/ml for water.

TABLE 38
Microbial counts on cantaloupes at 21° C. for 5 minutes in a 4-L tank

| | | Treated with 1.0% | | | Treated with 50 ppm | | | | | |
|---|---|---|---|---|---|---|---|---|---|---|
| | | levulinic acid plus | | | acidified sodium chlorite, | | | Treated with | | |
| | | 0.1% SDS, pH 3.1 | | | pH 4.6 | | | water only | | |
| Cantaloupe | Time | Microbial counts (log CFU/whole cantaloupe) | | | | | | | | |
| No. | (min) | Salmonella | APC | Y&M | Salmonella | APC | Y&M | Salmonella | APC | Y&M |
| 1 | 5 | 1.4 | 5.2 | 4.6 | 3.0 | 4.9 | 4.8 | 3.5 | 5.4 | 5.4 |
| 2 | 5 | 1.3 | 3.8 | 4.0 | 3.0 | 5.0 | 5.3 | 3.8 | 5.3 | 4.9 |
| 3 | 5 | 1.3 | 4.2 | 3.8 | 2.8 | 5.3 | 5.4 | 3.6 | 4.6 | 4.7 |
| 4 | 5 | 0.7 | 4.2 | 3.9 | 3.0 | 4.8 | 5.5 | 3.7 | 5.0 | 5.0 |
| 5 | 5 | 0.7 | 4.1 | 4.0 | 3.5 | 4.6 | 5.4 | 3.5 | 5.1 | 4.3 |
| 6 | 5 | 1.4 | 4.3 | 4.9 | 3.3 | 4.2 | 4.5 | 3.9 | 4.6 | 5.1 |
| 7 | 5 | 1.9 | 4.2 | 4.7 | 3.6 | 4.3 | 4.4 | 3.9 | 4.8 | 5.5 |
| 8 | 5 | 1.0 | 3.8 | 4.7 | 3.6 | 4.4 | 4.7 | 4.0 | 5.4 | 5.5 |
| 9 | 5 | 1.7 | 4.0 | 4.6 | 3.7 | 5.2 | 5.6 | 3.9 | 5.3 | 4.3 |
| 10 | 5 | 2.2 | 4.2 | 5.4 | 3.5 | 4.4 | 3.5 | 3.8 | 5.2 | 4.7 |

Inoculum level for S. typhimurium was 1.5×10⁶ CFU/ml. Background APC before inoculation for cantaloupe 1 was 5.6 log CFU/cantaloupe; cantaloupe 2 was 5.8 log CFU/cantaloupe.

Following inoculation, S. typhimurium count for cantaloupe 1 was 5.2 log S. typhimurium/cantaloupe; cantaloupe 2 was 5.0 log S. typhimurium/cantaloupe.

### Example 27

Increasing the concentration of levulinic acid plus SDS and reducing the treatment time to 2 min resulted in greater reduction of microbes. The average S. typhimurium count, APC, and yeast and mold counts on cantaloupes treated with water only were 3.62, 6.36, and 4.45 log CFU, respectively, whereas, the average S. typhimurium, APC, and yeast and mold counts on cantaloupes treated with 2% levulinic acid plus 0.2% SDS were 1.02, 5.15, and 3.45 log CFU/cantaloupe, respectively (Table 39). Hence, the average reduction of S. typhimurium, APC, and yeast and mold counts was 2.6, 1.21, and 1.03 log CFU/cantaloupe. The average of S. typhimurium count on cantaloupes treated with 50 ppm acidified sodium chlorite was 3.43 log CFU/cantaloupe, for a reduction of 0.19 log Salmonella CFU/cantaloupe (Table 39).

Following treatment, the microbial counts of the treatment solutions were <log 0.7 log S. typhimurium/ml, and 1.2 log Y&M/ml for the 2.0% levulinic acid plus 0.2% SDS treatment solution; were 1.9 log S. typhimurium, and 3.7 log Y&M/ml for the 50 ppm acidified sodium chlorite solution; and were 4.0 log S. typhimurium/ml, and 3.6 log Y&M/ml for the water treatment solution.

TABLE 39
Microbial counts on cantaloupes treated at 21° C. for 5 mins in a 4-L tank

| | | Treated with 2.0% | | | Treated with 50 ppm | | | | | |
|---|---|---|---|---|---|---|---|---|---|---|
| | | levulinic acid plus | | | acidified sodium | | | Treated with water | | |
| | | 0.2% SDS, pH 3.1 | | | chlorite, pH 4.6 | | | only | | |
| Cantaloupe | Time | Microbial counts (log CFU/whole cantaloupe) | | | | | | | | |
| No. | (min) | Salmonella | APC | Y&M | Salmonella | APC | Y&M | Salmonella | APC | Y&M |
| 1 | 2 | 1.5 | 6.6 | 4.3 | 3.7 | 6.4 | 4.8 | 3.8 | 6.4 | 4.0 |
| 2 | 2 | <0.7 | 5.8 | 3.7 | 3.6 | 6.1 | 4.9 | 3.8 | 6.1 | 5.6 |
| 3 | 2 | 1.0 | 4.6 | 3.2 | 3.3 | 5.3 | 5.0 | 3.5 | 6.7 | 4.8 |
| 4 | 2 | 1.2 | 5.9 | 3.8 | 3.5 | 7.0 | 5.1 | 3.4 | 6.3 | 4.4 |
| 5 | 2 | 1.7 | 4.2 | 3.4 | 3.7 | 6.0 | 4.8 | 3.6 | 6.4 | 4.1 |
| 6 | 2 | 1.0 | 5.2 | 2.8 | 3.3 | 6.3 | 5.1 | 3.7 | 6.8 | 4.8 |
| 7 | 2 | <0.7 | 5.2 | 2.8 | 3.2 | 6.2 | 5.1 | 3.3 | 5.9 | 4.1 |
| 8 | 2 | 0.7 | 4.8 | 2.5 | 3.5 | 6.8 | 4.5 | 3.7 | 6.2 | 4.0 |
| 9 | 2 | 0.7 | 4.4 | 4.0 | 3.1 | 6.7 | 4.0 | 3.7 | 6.7 | 4.6 |
| 10 | 2 | 1.2 | 4.8 | 4.0 | 3.4 | 6.6 | 4.5 | 3.7 | 6.1 | 4.4 |

Inoculum level for S. typhimurium is 1.5×10⁶ CFU/ml.

Background APC before inoculation of cantaloupe 1 was 7.3 log CFU/cantaloupe; cantaloupe 2 was 6.4 log CFU/cantaloupe.

Following inoculation, S. typhimurium count for cantaloupe 1 was 5.0 log S. typhimurium/cantaloupe; cantaloupe 2 was 5.2 log S. typhimurium/cantaloupe.

What is claimed:

1. A method of reducing a microbial population of a liquid, the method comprising contacting the liquid with a microbicidal composition comprising: about 0.5% to about 20% by weight per volume of levulinic acid and about 0.05% to about 5% by weight per volume of sodium dodecyl sulfate (SDS); about 0.5% to about 10% by weight per volume of levulinic acid and about 0.05% to about 3% by weight per volume of sodium dodecyl sulfate (SDS); about 0.5% to about 5% by weight per volume of levulinic acid and about 0.05% to about 2% by weight per volume of sodium dodecyl sulfate (SDS); or about 0.5% to about 3% by weight per volume of levulinic acid and about 0.05% to about 1% by weight per volume of sodium dodecyl sulfate (SDS).

2. The method of claim 1, wherein the liquid is suitable for consumption by an animal or human.

3. The method of claim 1, wherein the liquid has a pH value between about 0 and about 7.

4. The method of claim 2, wherein the liquid is water or a beverage.

5. The method of claim 4, wherein the beverage is a carbonated beverage.

6. The method of claim 4, wherein the beverage is a fruit juice, a vegetable-based beverage, a sugar syrup, a tea, an infusion, a coffee, an isotonic drink, a fermented beverage, or a milk-derived beverage.

7. The method of claim 1, wherein the microbicidal composition remains in the liquid after packaging of said liquid.

8. A method for decontaminating a solid surface of a beverage manufacturing facility, said method comprising the steps of contacting the solid surface with an aqueous composition comprising: about 0.5% to about 20% by weight per volume of levulinic acid and about 0.05% to about 5% by weight per volume of sodium dodecyl sulfate (SDS); about 0.5% to about 10% by weight per volume of levulinic acid and about 0.05% to about 3% by weight per volume of sodium dodecyl sulfate (SDS); about 0.5% to about 5% by weight per volume of levulinic acid and about 0.05% to about 2% by weight per volume of sodium dodecyl sulfate (SDS); or about 0.5% to about 3% by weight per volume of levulinic acid and about 0.05% to about 1% by weight per volume of sodium dodecyl sulfate (SDS).

9. The method of claim 8, wherein the solid surface is of beverage processing equipment or a beverage container.

10. The method of claim 9, wherein the beverage container is selected from the group consisting of: a bottle, a can, a carton, and a bag.
